(19) United States
(12) Patent Application Publication
(10) Pub. No.: US 2015/0281974 A1
(43) Pub. Date: Oct. 1, 2015

(54) Inter-Operator Time Sharing of Frequency Spectrum

(71) Applicant: TELEFONAKTIEBOLAGET L M ERICSSON (PUBL), Stockholm (SE)

(72) Inventors: Farshid Ghasemzadeh, Sollentuna (SE); Muhammad Kazmi, Bromma (SE); Klas Sjerling, Bromma (SE)

(73) Assignee: TELEFONAKTIEBOLAGET L M ERICSSON (PUBL), Stockholm (SE)

(21) Appl. No.: 14/437,274

(22) PCT Filed: May 30, 2013
(86) PCT No.: PCT/SE2013/050626

§ 371 Date: Apr. 21, 2015

Related U.S. Application Data
(60) Provisional application No. 61/719,606, filed on Oct. 29, 2012.

(51) Int. Cl. H04W 16/14; H04L 5/14; H04W 72/04

(52) U.S. Cl. CPC H04W 16/14; H04W 72/0453; H04L 5/14

(57) ABSTRACT

Disclosed are methods as well as apparatuses for inter-operator time-sharing of a frequency spectrum. In one example embodiment, the same frequency spectrum is allocated to each of a plurality of operators during different time periods such that the same frequency spectrum is shared among all of the plurality of operators.

### TECHNICAL FIELD

The subject matter described herein generally relates to wireless communications networks. In particular, the subject matter relates to methods, apparatuses, and/or systems for inter-operator time sharing of frequency spectrum.

### BACKGROUND

This section is intended to provide a background to the various embodiments of the technology that are described in this disclosure. The description herein may include concepts that could be pursued, but are not necessarily ones that have been previously conceived or pursued. Therefore, unless otherwise indicated herein, what is described in this background section is not prior art to the description and/or claims of this disclosure and is not admitted to be prior art by the mere inclusion in this section.

In a synchronized TDD system, adjacent carrier frequencies or carriers close to each other in the frequency domain are frame synchronized (i.e., have same or almost the same frame start timings) and use the same TDD configuration (i.e., same UL/DL/special subframe configuration). In an unsynchronized TDD system, adjacent carrier frequencies or carriers close to each other in the frequency domain can use different TDD configuration and/or can have any frame start timings. For ease of reference, “adjacent carriers” will be used herein to refer to adjacent carrier frequencies and/or carriers close to each other in the frequency domain.

Adjacent carriers may belong to different operators. To mitigate interfering with each other, operators may choose to synchronize their TDD operations. This means that the operators must generally agree on the TDD configuration to be used on the adjacent carriers. One disadvantage of the synchronized TDD is that the operators may be prevented from choosing a TDD configuration that may be more suitable to each operator's traffic demand.

Operators can choose to operate using unsynchronized TDD so that each operator can choose its own TDD configuration on its carrier. This means that the frames of the adjacent carriers can be misaligned and the TDD configuration can be different. This can lead to significant interference issues. BS-to-BS (base station to base station) interference can thus be of particular concern.

To mitigate such interference issues in unsynchronized TDD, a sufficient guard band (e.g., 5 MHz) is generally required between the unsynchronized carriers. This leads to a waste of spectrum which could otherwise be used to carry traffic. This can also lead to requiring a vendor to implement operator specific RF components (e.g., RF filters, power amplifiers, etc) for each unsynchronized carrier frequency.

In some countries, regulators are also assigning the unused spectrum (e.g., guard bands) for some other operation or technology including non-cellular technologies. These auxiliary operations may lead to further challenges with respect to coexistence issues. A particular problem is observed in some countries where regulators do not adopt common allocation of spectrum, sizes of guard bands, and/or restricted blocks.

Restricted blocks are used in Europe where such frequency blocks are highly restricted in the allowed level of operational power or unwanted emissions. This may further accentuate the need for BS equipment that is capable of meeting radio related regulatory requirements under the constraint of different allocation and different level of inter-operator guard band and/or restricted block. Customized solutions to address particular challenges in different regions may in turn increase the cost, effort and complexity of the equipment, apart from the wastage of the spectrum in form of guard band/restricted blocks.

A frequency band or an operating frequency band supports a specific duplex mode of operation. The possible duplex modes are:
FDD—frequency division duplex:
   Used in e.g., UTRAN FDD and E-UTRAN FDD;
   UL (uplink) and DL (downlink) transmissions take place on different paired carrier frequency channels;
   UL and DL transmissions can occur simultaneously in time;
TDD—time division duplex:
   Used in e.g., UTRAN TDD and E-UTRAN TDD;
   UL and DL transmissions take place on same carrier frequency channel in different time slots or subframes;
HD-FDD—half duplex FDD (can be regarded as a hybrid scheme):
   Used in e.g., GSM, GPRS, GERAN, EDGE;
   Like FDD mode, UL and DL transmissions take place on different paired carrier frequency channels;
   Unlike FDD mode, UL and DL transmissions do not occur simultaneously in time;
   Like TDD mode, UL and DL transmissions can take place in different time slots or subframes.

There is also another special case of FDD band called “downlink FDD band” (aka DL FDD only band). A well known example is that of LTE (Long Term Evolution) DL FDD band (e.g., 717-728 MHz), which is being standardized. It does not have UL part of the spectrum. Therefore, for UL transmission the DL FDD band is always used in carrier aggregation mode with another FDD or TDD band such as LTE FDD band 2.

LTE (Long Term Evolution) operates in different duplex modes including FDD, TDD and half duplex FDD. LTE TDD uses unpaired spectrum, which is similar to other TDD systems such as UTRA TDD and TD-SDMA. In LTE, DL and UL transmission are based on radio frames of 10 ms duration. There are two radio frame structures—type 1 for FDD and type 2 for TDD. A Type 2 frame structure is applicable to LTE TDD system [see e.g. reference 1], and is illustrated in FIG. 1, which illustrates the time domain radio frame structure.

Each 10 ms radio frame consists of two 5 ms half-frames, and each half-frame consists of five 1 ms subframes. Each subframe is one of a DL subframe, a UL subframe or a special subframe (or simply S subframe). Each subframe can be further subdivided. As seen, each UL and DL subframe is divided into two slots, each of 0.5 ms duration. The S subframe is divided into fields DwPTS (downlink pilot time slot), GP (guard period), and UpPTS (uplink pilot time slot). The sum durations of DwPTS, GP, and UpPTS is equal to 1 ms. Different combinations of DL, UL, and S subframes give rise to different TDD configurations.

The supported UL-DL configurations in LTE TDD are listed in Table 1, where for each subframe of the radio frame, “D” denotes that the subframe is reserved for DL transmissions, “U” denotes that the subframe is reserved for UL transmissions and “S” denotes a special subframe. As seen, UL-DL configurations with both 5 ms and 10 ms DL-to-UL switch-point periodicity are supported. In case of 5 ms periodicity, the S subframe exists in both half-frames. In case of 10 ms periodicity, the S subframe exists in the first half-frame only.

TABLE 1
LTE TDD UL-DL configurations

| | Downlink- | | | | | | | | | | |
|---|---|---|---|---|---|---|---|---|---|---|---|
| | to-Uplink | | | | | | | | | | |
| Uplink- | Switch- | | | | | | | | | | |
| downlink | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Regarding the S subframe, the durations of DwPTS and UpPTS are given in Table 2, and are subject to a condition that the total duration of DwPTS, GP and UpPTS is equal to 1 ms.

TABLE 2
LTE TDD special subframe configuration (lengths of DwPTs/GP/UpPTS)

| | Normal cyclic prefix in downlink | | | Extended cyclic prefix in downlink | | |
|---|---|---|---|---|---|---|
| | | UpPTS | | | UpPTS | |
| | | Normal | Extended | | Normal | |
| Special | | cyclic | cyclic | | cyclic | Extended |
| subframe | | prefix in | prefix in | | prefix in | cyclic prefix |
| configuration | DwPTS | uplink | uplink | DwPTS | uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | | |
| 8 | 24144 · Tₛ | | | — | | |

Subframes 0 and 5 and DwPTS are always reserved for DL transmissions. UpPTS and the subframe immediately following the S subframe is always reserved for UL transmission. This means subframe 2 is always reserved for UL. For the 5 ms periodicity, subframe 7 is also reserved for UL. Subframes 3, 4, 8, 9 may be reserved for either UL or DL. For 10 ms DL-to-UL switch point periodicity, subframe 7 may also be reserved for either UL or DL.

In a TDD cell, the TDD configuration is characterized by UL-DL-S subframe configuration. In this disclosure, the term “TDD configuration” used hereinafter refers to a combination of UL-DL configuration (e.g., one of in Table 1) and S subframe configuration (e.g., one of in Table 2) configured in the TDD cell.

The subject matter is not limited to the configurations listed in Tables 1 and 2. Also, the subject matter is not limited to TDD configuration—one or more aspects are applicable to other configurations including FDD, HD-FDD, DL FDD band, among others.

In TDD mode, the radio transceiver in the UE and in the radio node (e.g., base station) switches between the receiver and the transmitter for receiving and transmitting the radio signals. The change in the direction from DL to UL and vice versa is commonly called as RX/TX (or TX/RX) switching.

The requirements related to the TX (transmitter)/RX (receiver) switching are predefined for both UE and BS. For a LTE base station, the 3GPP specification indicates that the durations of DL and UL transient periods are 17 μs. The transient periods define time periods during which the DL and UL subframes change states from the OFF to ON periods and vice versa, [see for example reference 7]. The DL/UL/DL transient period for the LTE TDD base station is illustrated in FIG. 2. In practice, the transceivers are likely to transient periods shorter than 17 μs for both transitions from OFF to ON and from ON to OFF.

New frequency bands for different technologies are being standardized with an ever increasing pace. Various internal and regional regulatory organizations and standardization bodies are also expending considerable effort in introducing these bands to be widely used to facilitate roaming, to simplify device implementation, and to reduce costs. Due to the increasing demand for mobile services coupled with scarcity of spectrum (e.g., scarcity of spectrum below 1 GHz range is a particular concern) efficient use of the available spectrum is becoming particularly important.

Standard bodies such as 3GPP are specifying frequency bands and associated aspects including frequency band number (aka band indicator), channel arrangement, signaling and requirements for different bands. These standardized principles and requirements can potentially be used in different countries or regions. They enable the mobile terminal and network manufacturers to build products according to the need and market demands in different parts of the world.

TABLE 3
E-UTRA operating bands

| | Uplink (UL) operating band | Downlink (DL) operating band | |
|---|---|---|---|
| | BS receive | BS transmit | |
| E-UTRA | UE transmit | UE receive | Duplex |
| Operating Band | F_{UL}_{_{—}}_{low}-F_{UL}_{_{—}}_{high} | F_{DL}_{_{—}}_{low}-F_{DL}_{_{—}}_{high} | Mode |
| 1 | 1920 MHz-1980 MHz | 2110 MHz-2170 MHz | FDD |
| 2 | 1850 MHz-1910 MHz | 1930 MHz-1990 MHz | FDD |
| 3 | 1710 MHz-1785 MHz | 1805 MHz-1880 MHz | FDD |
| 4 | 1710 MHz-1755 MHz | 2110 MHz-2155 MHz | FDD |
| 5 | 824 MHz-849 MHz | 869 MHz-894 MHz | FDD |
| 6¹ | 830 MHz-840 MHz | 875 MHz-885 MHz | FDD |
| 7 | 2500 MHz-2570 MHz | 2620 MHz-2690 MHz | FDD |
| 8 | 880 MHz-915 MHz | 925 MHz-960 MHz | FDD |
| 9 | 1749.9 MHz-1784.9 MHz | 1844.9 MHz-1879.9 MHz | FDD |
| 10 | 1710 MHz-1770 MHz | 2110 MHz-2170 MHz | FDD |
| 11 | 1427.9 MHz-1447.9 MHz | 1475.9 MHz-1495.9 MHz | FDD |
| 12 | 699 MHz-716 MHz | 729 MHz-746 MHz | FDD |
| 13 | 777 MHz-787 MHz | 746 MHz-756 MHz | FDD |
| 14 | 788 MHz-798 MHz | 758 MHz-768 MHz | FDD |
| 15 | Reserved | Reserved | FDD |
| 16 | Reserved | Reserved | FDD |
| 17 | 704 MHz-716 MHz | 734 MHz-746 MHz | FDD |
| 18 | 815 MHz-830 MHz | 860 MHz-875 MHz | FDD |
| 19 | 830 MHz-845 MHz | 875 MHz-890 MHz | FDD |
| 20 | 832 MHz-862 MHz | 791 MHz-821 MHz | FDD |
| 21 | 1447.9 MHz-1462.9 MHz | 1495.9 MHz-1510.9 MHz | FDD |
| 22 | 3410 MHz-3490 MHz | 3510 MHz-3590 MHz | FDD |
| 23 | 2000 MHz-2020 MHz | 2180 MHz-2200 MHz | FDD |
| 24 | 1626.5 MHz-1660.5 MHz | 1525 MHz-1559 MHz | FDD |
| 25 | 1850 MHz-1915 MHz | 1930 MHz-1995 MHz | FDD |
| 26 | 814 MHz-849 MHz | 859 MHz-894 MHz | FDD |
| . . . | | | |
| 33 | 1900 MHz-1920 MHz | 1900 MHz-1920 MHz | TDD |
| 34 | 2010 MHz-2025 MHz | 2010 MHz-2025 MHz | TDD |
| 35 | 1850 MHz-1910 MHz | 1850 MHz-1910 MHz | TDD |
| 36 | 1930 MHz-1990 MHz | 1930 MHz-1990 MHz | TDD |
| 37 | 1910 MHz-1930 MHz | 1910 MHz-1930 MHz | TDD |
| 38 | 2570 MHz-2620 MHz | 2570 MHz-2620 MHz | TDD |
| 39 | 1880 MHz-1920 MHz | 1880 MHz-1920 MHz | TDD |
| 40 | 2300 MHz-2400 MHz | 2300 MHz-2400 MHz | TDD |
| 41 | 2496 MHz 2690 MHz | 2496 MHz 2690 MHz | TDD |
| 42 | 3400 MHz-3600 MHz | 3400 MHz-3600 MHz | TDD |
| 43 | 3600 MHz-3800 MHz | 3600 MHz-3800 MHz | TDD |

NOTE:
¹Band 6 is not applicable

In 3GPP, several frequency bands have been specified for different technologies: GSM/GERAN [see e.g. reference 8], UTRAN FDD [see e.g. references 2-3], UTRAN TDD [see e.g. references 4-5], LTE FDD (E-UTRAN FDD) [see e.g. references 6-7] and LTE TDD (E-UTRAN TDD) [see e.g. references 6-7]. The currently standardized LTE FDD and TDD frequency bands are shown in Table 3.

Carrier frequencies in a frequency band are enumerated. The enumeration is generally standardized such that a particular combination of a frequency band and carrier frequency can be determined by a unique number called absolute radio frequency number. In GSM/GERAN, UTRAN and E-UTRAN, the channel numbers are respectively referred to as ARFCN (Absolute Radio Frequency Channel Number), UARFCN and EARFCN.

In FDD systems, separate channel numbers are specified for UL and DL. In TDD there is only one channel number since the same carrier is used in both directions.

The channel number for each band is sufficiently unique to enable different bands to be distinguished. The channel number for a band can be derived from expressions and mapping tables defined in the relevant specifications for each technology. Based on the signaled channel number (e.g., EARFCN) and predefined parameters associated with each band, the UE can determine the actual carrier frequency and the corresponding frequency band. For example the relation between the EARFCN and a DL carrier frequency F_{DL} in MHz (megahertz) is predefined in LTE by the following equation in [see e.g. references 6-7]:

F_{DL}=F_{DL}_{_{—}}_{low}+0.1(N_{DL}−N_{Offs-DL}) (1)

where F_{DL}_{_{—}}_{low} (base DL carrier frequency in MHz) and N_{Offs-DL} (base channel number) are predefined values in references 3-4, respectively, for each band, and N_{DL} is the DL EARFCN (DL channel number).

As an illustration, consider the E-UTRA band 5, whose EARFCN N_{DL} as predefined in references 6-7, respectively, lies between 2400-2649. The predefined values of F_{DL}_{_{—}}_{low} and N_{Offs}_{_{—}}_{DL} are 869 and 2400 respectively. Assume that the network signals N_{DL}=2500 as the DL channel number. Using the above equation (1), the UE can determine that the DL carrier frequency F_{DL} of the channel is 879 MHz. As indicated above, the predefined EARFNC range is unique for each band. Hence, the UE can determine the frequency band corresponding to the signaled EARFNC. An expression to derive the E-UTRA FDD UL carrier frequency, which is similar to that of the DL carrier frequency, is also predefined.

In E-UTRA FDD, both fixed transmit-receive frequency separation (e.g., fixed duplex) and variable transmit-receive frequency separation (e.g., variable duplex) are supported. If a network uses fixed duplex for a DL carrier, then the network only needs to signal the channel number corresponding to the band, i.e., only the DL EARFCN needs to be signaled, since the UE can determine the UL carrier from the DL carrier (from equation (1)) and the predefined duplex gaps in references 6-7. On the other hand, if the network uses variable duplex, it should signal both DL and UL channel numbers, i.e., signal both DL and UL EARFCNs to the UE.

The frequency bands specified in 3GPP or in other standardization organizations may allow cellular manufacturers to build terminal and network products. However, it is generally up to the regional or even country wide regulatory or any relevant authority to decide whether a certain frequency band is allowed or not in their jurisdiction.

Generally, a particular frequency band or spectrum is split into multiple chunks, and in turn the multiple chunks are assigned to multiple operators in a country, a region, a province, etc by the relevant frequency allocation authority or similar. A band may also be operator specific in which case it is entirely owned by one operator. An operator specific band is more common when the pass band (i.e., available spectrum) is small or comparable to channel bandwidth or typically channel bandwidth of a technology. But in most cases, a band is divided among multiple operators. An example allocation of a TDD frequency band to different operators is illustrated FIG. 3A.

But as shown in FIG. 3B, a practical deployment comprising of unsynchronized TDD carriers belonging to different operators generally requires a guard band and/or a restricted block (e.g., 5 MHz) between at least adjacent carriers to mitigate interference issues. For purposes of this disclosure, the expressions guard band and restricted block may be used interchangeably unless explicitly indicated otherwise. Generally, transmissions on the guard band are not allowed or allowed only under severe restrictions such as transmission with very low power. For the purposes of this document, it may be assumed that little to no meaningful transmission occurs on the guard bands.

In an unsynchronized TDD system, different carriers have arbitrary frame start timings and/or different TDD configurations. Note that FDD frequency band can also be divided among operators as shown in FIG. 4.

Since a band of frequency can generally be used for more than one technology, the band can potentially be also split for different technologies, and the split can vary from one region to another. For instance, the UTRAN FDD band 1 and E-UTRAN FDD band 1 are generally considered to be relatively universal as they are widely available and allocated in a relatively large number of countries across the globe. But they can also be shared among different technologies, and the actual split across technologies can vary.

In the USA, the Federal Communications Commissions (FCC) is generally responsible for attributing licenses for various Wireless Communications Service (WCS) including fixed, mobile, radiolocation or satellite services. Similarly in Europe, the Electronic Communications Committee (ECC), which is part of the European conference of postal and telecommunications administrations (CEPT), is responsible for radio communications. More specifically European Radio communications Office (ERO) supports ECC in developing and maintaining the frequency allocation for CEPT member countries. As of today, there are 48 CEPT member countries. Ultimately, each member country has its own frequency allocation. However, the ERO allocation table is used as the basis for developing national frequency allocation. Similar regional organizations are active in other parts of the world for allocating frequencies in their region for different technologies to different operators.

In summary, the actual frequency bands used in a particular region or a country are generally regulated by regional or country wide organizations responsible for frequency allocation in their respective regions.

### Multi-Carrier or Carrier Aggregation

It is generally known that in order to enhance peak rates within a technology, multi-carrier or carrier aggregation (CA) can be used. For example, it is possible to use multiple 5 MHz carriers in HSPA (High Speed Packet Access) to enhance the peak rate within the HSPA network. Similarly in LTE, multiple 20 MHz carriers or even smaller carriers (e.g., 5 MHz) can be aggregated in the UL and/or in the DL. Each carrier in the multi-carrier or carrier aggregation system is generally termed as a component carrier (CC) and is also sometimes referred to a cell. A component carrier (CC) may be viewed as an individual carrier in a multi-carrier system.

The term carrier aggregation can be interchangeably called “multi-carrier system”, “multi-cell operation”, “multi-carrier operation”, “multi-carrier transmission” and/or “multi-carrier reception”. CA can be used for transmission of signaling and data in the UL and/or the DL directions.

One CC of the CA is the primary component carrier (PCC) and may also be referred to as the primary carrier or anchor carrier. Each of the remaining CCs is a secondary component carrier (SCC), and may also be referred to as a secondary carrier or supplementary carrier. Generally, the PCC carries the essential UE specific signaling and exists in both UL and DL directions in CA. In case there is single UL CC, the UE specific signaling is on that CC. The network may assign different primary carriers to different UEs operating in the same sector or cell.

Therefore, a UE can have more than one serving cell in DL and/or in the UL: one primary serving cell operating on the PCC and one or more secondary serving cells operating on one or more SCCs. The primary serving cell (PSC) can be interchangeably referred to as the primary cell (PCell). Similarly, each secondary serving cell (SSC) can be interchangeably referred to as the secondary cell (SCell). Regardless of the terminology, the PCell and SCell(s) enable the UE to receive and/or transmit data. More specifically, the PCell and SCell exist in DL and UL for the reception and transmission of data by the UE. The remaining non-serving cells on the PCC and SCC are called neighbor cells.

The CCs belonging to the CA may belong to the same frequency band (intra band CA), to different frequency bands (inter-band CA), or any combination thereof (e.g., 2 CCs in band A and 1 CC in band B). An inter-band CA that includes carriers distributed over two bands may also be called as dual-band-dual-carrier-HSDPA (DB-DC-HSDPA) in HSPA or inter-band CA in LTE. The CCs of an intra-band CA may be adjacent (intra-band adjacent CA) or non-adjacent (intra-band non-adjacent CA) in the frequency domain. A hybrid CA that includes any combination of intra-band adjacent, intra-band non-adjacent and inter-band CCs is also possible.

Using carrier aggregation between carriers of different technologies is possible. For example, the carriers from WCDMA and LTE may be aggregated. Another example is the aggregation of LTE and CDMA2000 carriers. Such carrier aggregation can be interchangeably referred to as “multi-RAT carrier aggregation”, “multi-RAT-multi-carrier system” or simply “inter-RAT carrier aggregation”. For the sake of clarity, carrier aggregation within the same technology as described can be regarded as “intra-RAT” or “single RAT” carrier aggregation.

The multi-carrier operation may also be used in conjunction with multi-antenna transmission such as MIMO (multiple-input-multiple-output). For example, signals on each CC may be transmitted by the eNB to the UE over two or more antennas.

The CCs in CA may or may not be co-located at the same site or base station or radio network node (e.g., relay node, mobile relay node, etc.). For instance the CCs may originate (i.e., transmitted/received) at different locations (e.g., from non-co-located BS or from BS and RRH or RRU). Examples of combined CA and multi-point communication are DAS, RRH, RRU, CoMP, multi-point transmission/reception, and the like. The subject matter described later in this disclosure is applicable to multi-point carrier aggregation systems, i.e., is applicable to each CC in CA or in CA combination with CoMP, and so on.

### Self Organizing Network

Advanced technologies such as E-UTRAN and UTRAN may employ the concept of self organizing network (SON). The objective of a SON entity is to allow operators to automatically plan and tune the network parameters and configure the network nodes.

Typically, tuning is performed manually, which may consume an enormous amount of time, resources and which may require considerable involvement of work force. In particular due to the network complexity, large number of system parameters, IRAT technologies, etc., it is very attractive to have reliable schemes and mechanisms that can automatically configure the network whenever necessary. This can be realized by a SON, which can be visualized as a set of algorithms and protocols performing the task of automatic network tuning and configuration. To perform automatic tuning and configuration, the SON node generally requires measurement reports and results from other nodes such as the UE and the base station. The SON can also be used for automatically changing the state of cells from active to idle or vice versa.

Typically, regulators may divide a frequency spectrum or a frequency band available for wireless communication into several blocks of spectrum or frequencies. One or multiple frequency blocks are then assigned to different operators. A small frequency band may also be entirely assigned to a single operator. However, most frequency bands are large enough and are split among multiple operators.

The frequency assignment principle and criteria depend upon the particular regulatory authority. For example, the TDD frequency band 38 (2.6 GHz—see Table 3 above) can be divided into 10 blocks, in which each block is 5 MHz wide. This 50 MHz spectrum can be divided among three operators: 3×5 MHz, 3×5 MHz and 4×5 MHz. If the operators want unsynchronized TDD operation, one main drawback may be that each operator will have to sacrifice e.g., 5 MHz of their spectrum to introduce inter-operator guard band and/or restricted block. Another potential drawback is that the vendor has to develop customized radio network equipment for each operator.

The operators can use synchronized TDD operation to remove the need to sacrifice a part of their allocated spectrum. However, in order to ensure synchronized TDD operation, the operators generally need to coordinate and agree on a common TDD UL and/or DL configuration (i.e., common frame alignment and common TDD UL/DL configuration). However the coordination and determination of the most suitable TDD configuration for all operators using adjacent carriers in the same TDD band may be quite challenging in some scenarios. This may be because the optimum use of a TDD configuration depends upon several factors including type of services, symmetry or distribution between UL and DL traffic, cell size, radio environment, etc.

It may be almost impossible or at least quite challenging to determine a common TDD configuration that can satisfy the demand of all operators due to differences in one more requirements mentioned above. For example an operator which mainly offers data services may require a TDD configuration with a larger number of DL subframes compared to UL subframes in a frame. Another operator which mainly offers voice services may require TDD configuration with equal allocation of DL and UL resources (i.e., subframes) in a frame. Yet a third operator may have a very larger number of the subscribers uploading files or sending data. Such operator may require TDD configuration with larger number of UL subframes compared to the DL subframes in a frame. The traffic demand and the types of services used by the subscribers may also change over time. In such scenarios, the coordination among the operators becomes even more complex.

The problem, or challenge, described above is more severe for TDD bands due to cross UL-DL subframe and/or slot interference, which can be mitigated either by introducing guard band/restricted blocks (see FIG. 3B) or by synchronized operation among operators using adjacent carriers in the same band (see FIG. 3A).

The current LTE TDD co-existence and co-location radio requirements for UE and BS are defined in references 6-7 under the assumption that all TDD carriers are synchronized, i.e., they use the same TDD configuration and are frame synchronized. This means there are generally no requirements for unsynchronized operation and this may lead to severe performance degradation if TDD carriers are not synchronized in practice.

Note that regardless of whether synchronized or unsynchronized operation is used, a peak rate that an operator can provide depends on the amount of spectrum assigned to that operator. In the above example, the peak rates that can be offered by the three operators may be limited due to the peak rate that can be carried on frequency spectrums that are 15 MHz, 15 MHz, and 20 MHz wide, respectively.

The FDD band can also be split among multiple operators (see FIG. 4). The peak data rate offered by an FDD operator also depends upon the amount of the spectrum assigned to that operator. For example, an FDD operator assigned 10 MHz in band 1 (2 GHz—see Table 3) can offer services using LTE channel up to 10 MHz channel. Such operator cannot offer higher data rate using other larger LTE channels such as 15 or 20 MHz channel. Similarly the operator also cannot use intra-band CA to further enhance the bit rate.

Time sharing of spectrum is used by wireless devices to access unlicensed spectrum such as Wi-fi or WLAN. In this approach, a wireless device upon sensing an unused spectrum starts using it for wireless communication temporarily. The access is aperiodic, i.e. non-periodic, which means the spectrum has to be accessed every time the wireless communication takes place or is established. This in turn may result in collision between transmissions by differences devices. But the main problem, or challenge, is that the conventional approach does not give long term or regular access of spectrum resources to an operator. This can be problematic or at least challenging since a number of services and several measurements require more regular access to the radio spectrum.

### SUMMARY

It is in view of above considerations and others that the various embodiments disclosed herein have been made.

To address the above considerations and others, one or more methods, apparatuses and/or systems are therefore described herein. A novel inter-operator time sharing of frequency spectrum is implemented.

According to an aspect, there is provided a method of allocating a radio spectrum to a plurality of operators. The method comprises allocating a same frequency spectrum to each operator of the plurality of operators during different time periods such that the same frequency spectrum is shared among the plurality of operators. For example, the method may comprise allocating the same frequency spectrum to a first operator during a first time period; allocating the same frequency spectrum to a second operator during a second time period, which is subsequent to the first time period; and allocating the same frequency spectrum to a third operator during a third time period, which is subsequent to the second time period. Furthermore, the method may comprise allocating the same frequency spectrum to the first operator during a fourth time period, which is subsequent to the third time period; allocating the same frequency spectrum to the second operator during a fifth time period, which is subsequent to the fourth time period; and allocating the same frequency spectrum to the third operator during a sixth time period, which is subsequent to the fifth time period. The different time periods may be non-overlapping in time. Moreover, the different time periods may be equal in length. Alternatively, the different time periods may be unequal in length. Also, any two adjacent time periods may be separated by a guard time.

According to another aspect, there is provided a method performed by a radio network node. The method comprises acquiring information relating to an allocation of a same frequency spectrum to each operator of a plurality of operators during different time periods, wherein the same frequency spectrum is shared among the plurality of operators; and performing radio communication based on the acquired information.

The acquiring of information may comprise acquiring the information from another node. Additionally, or alternatively, the acquiring of information may comprise acquiring the information from information stored in the radio network node.

The above-mentioned acquired information may include one or more parameters that identify the same frequency spectrum and one or more parameters that identify a plurality of different time periods corresponding to the plurality of operators that are sharing the same frequency spectrum during the different time periods. For example, the method may also comprise performing, based on said acquired information, a first radio communication in a first time period of said plurality of time periods.

The method may also comprise transmitting capability information to another radio network node or to a user equipment, wherein said capability information indicates that the radio network node is capable of performing radio communication sharing the same frequency spectrum during at least one of the different time periods allocated to different operators. Additionally, or alternatively, the method may comprise receiving capability information from another network node, wherein said capability information indicates that said another radio network node is capable of performing radio communication sharing the same frequency spectrum during at least one of the different time periods allocated to different operators. Additionally, or alternatively, the method may comprise receiving capability information from a user equipment, wherein said capability information indicates that said user equipment is capable of performing radio communication sharing the same frequency spectrum during at least one of the different time periods allocated to different operators. Also, the method may further comprise relaying, or forwarding, the received capability information from said user equipment to another radio network node.

According to still another aspect, there is provided a method performed by a user equipment (UE). The method comprises acquiring information relating to an allocation of a same frequency spectrum to each operator of a plurality of operators during different time periods, wherein the same frequency spectrum is shared among the plurality of operators; and performing radio communication based on the acquired information.

The acquiring of information may comprise acquiring the information from a memory of the UE. Additionally, or alternatively, the acquiring of information may comprise receiving the information from a network node. Additionally, or alternatively, the acquiring of information may comprise receiving the information from another UE.

Said acquired information may include one or more parameters that identify the same frequency spectrum and one or more parameters that identify a plurality of different time periods corresponding to the plurality of operators that are sharing the same frequency spectrum during the different time periods. Moreover, the method may comprise performing, based on said acquired information, a first radio communication in a first time period of said plurality of time periods.

The method may further comprise transmitting capability information to a radio network node or to anotheruser equipment, wherein said capability information indicates that the user equipment is capable of performing radio communication sharing the same frequency spectrum during at least one of the different time periods allocated to different operators. Additionally, or alternatively, the method may comprise receiving capability information from anotheruser equipment, wherein said capability information indicates that said another user equipment is capable of performing radio communication sharing the same frequency spectrum during at least one of the different time periods allocated to different operators. Additionally, or alternatively, the method may comprise receiving capability information from a radio network node, wherein said capability information indicates that said radio network node is capable of performing radio communication sharing the same frequency spectrum during at least one of the different time periods allocated to different operators.

According to another aspect, there is provided an apparatus for allocating a radio spectrum to a plurality of operators. The apparatus comprises a processor and a memory storing computer program code, which, when run in the processor causes the apparatus to allocate a same frequency spectrum to each operator of the plurality of operators during different time periods such that the same frequency spectrum is shared among the plurality of operators. In one embodiment, the memory and computer program are configured to, together with the processor, allocate the same frequency spectrum to a first operator during a first time period; allocate the same frequency spectrum to a second operator during a second time period, which is subsequent to the first time period; and allocate the same frequency spectrum to a third operator during a third time period, which is subsequent to the second time period. Furthermore, the memory and computer program may be further configured to, together with the processor, allocate the same frequency spectrum to the first operator during a fourth time period, which is subsequent to the third time period; allocate the same frequency spectrum to the second operator during a fifth time period, which is subsequent to the fourth time period; and allocate the same frequency spectrum to the third operator during a sixth time period, which is subsequent to the fifth time period. The above-mentioned different time periods may be non-overlapping in time. Moreover, the different time periods may be equal in length. Alternatively, the different time periods may be unequal in length. Also, any two adjacent time periods may be separated by a guard time.

According to yet another aspect there is provided a radio network node. The radio network node comprises a wireless interface; a processor; and a memory storing computer program code, which, when run in the processor causes the radio network node to acquire information relating to an allocation of a same frequency spectrum to each operator of a plurality of operators during different time periods, wherein the same frequency spectrum is shared among the plurality of operators; wherein the wireless interface is configured to perform radio communication based on the acquired information.

In one embodiment, the radio network node is configured to acquire said information from another radio network node. To this end, the wireless interface may be configured to receive said information from another radio network node. In one embodiment, the radio network node may be configured to acquire the information from information stored (e.g. in a memory) in the radio network node. The above-mentioned acquired information may include one or more parameters that identify the same frequency spectrum and one or more parameters that identify a plurality of different time periods corresponding to the plurality of operators that are sharing the same frequency spectrum during the different time periods. For example, the wireless interface may be configured to perform, based on said acquired information, a first radio communication in a first time period of said plurality of time periods.

The wireless interface may also be configured to transmit capability information to another radio network node or to a user equipment, wherein said capability information indicates that the radio network node is capable of performing radio communication sharing the same frequency spectrum during at least one of the different time periods allocated to different operators. Additionally, or alternatively, the wireless interface may be configured to receive capability information from another network node, wherein said capability information indicates that said another radio network node is capable of performing radio communication sharing the same frequency spectrum during at least one of the different time periods allocated to different operators. Additionally, or alternatively, the wireless interface may be configured to receive capability information from a user equipment, wherein said capability information indicates that said user equipment is capable of performing radio communication sharing the same frequency spectrum during at least one of the different time periods allocated to different operators. Also, the wireless interface may be further configured to relay, or forward (i.e. transmit), the received capability information from said user equipment to another radio network node.

According to still a further aspect, a user equipment (UE) is provided. The UE comprises a wireless interface; a processor; and a memory storing computer program code, which, when run in the processor causes the UE to acquire information relating to an allocation of a same frequency spectrum to each operator of a plurality of operators during different time periods, wherein the same frequency spectrum is shared among the plurality of operators; wherein the wireless interface is configured to perform radio communication based on the acquired information.

The acquiring of information may comprise acquiring the information from a memory of the UE. Additionally, or alternatively, the wireless interface may be configured to receive the information from a network node. Additionally, or alternatively, the wireless interface may be configured to receive the information from another UE. Said acquired information may include one or more parameters that identify the same frequency spectrum and one or more parameters that identify a plurality of different time periods corresponding to the plurality of operators that are sharing the same frequency spectrum during the different time periods. Moreover, the wireless interface may be configured to perform, based on said acquired information, a first radio communication in a first time period of said plurality of time periods.

The wireless interface may also be configured to transmit capability information to a radio network node or to anotheruser equipment, wherein said capability information indicates that the user equipment is capable of performing radio communication sharing the same frequency spectrum during at least one of the different time periods allocated to different operators. Additionally, or alternatively, the wireless interface may be configured to receive capability information from anotheruser equipment, wherein said capability information indicates that said another user equipment is capable of performing radio communication sharing the same frequency spectrum during at least one of the different time periods allocated to different operators. Additionally, or alternatively, the wireless interface may be configured to receive capability information from a radio network node, wherein said capability information indicates that said radio network node is capable of performing radio communication sharing the same frequency spectrum during at least one of the different time periods allocated to different operators.

### BRIEF DESCRIPTION OF THE DRAWINGS

These and other aspects, features and advantages of the embodiments of this disclosure will be apparent and elucidated from the following description of embodiments, reference being made to the accompanying drawings in which:

FIG. 1 illustrates a time domain radio frame structure (type 2) for LTE TDD;

FIG. 2 shows an illustration of the relations of a transmitter ON period, a transmitter OFF period and a transmitter transient period in a LTE TDD BS;

FIG. 3A shows an example allocation of a TDD frequency band to four different operators equally split among the operators;

FIG. 3B shows unsynchronized TDD carriers belonging to four different operators, wherein guard bands are required between adjacent carriers;

FIG. 4. Shows an example allocation of a FDD frequency band to four different operators—also equally split among the operators;

FIG. 5 is a flow chart of an example method of inter-operator time sharing of frequency spectrum;

FIG. 6 shows an example assignment of radio spectrum Fs by splitting it equally among three different operators using conventional technique—TDD operation requiring guard band/restricted block between carriers;

FIG. 7 shows a time sharing example, where an entire, or same, available spectrum Fs is shared by operators for TDD operation in different time slots of equal length (τ);

FIG. 8 shows another time sharing example, where an entire, or same, available spectrum Fs shared by operators for TDD operation in different time slots of differing lengths (τ1, τ2, τ3);

FIG. 9 shows still another time sharing example—an available spectrum Fs is shared by operators for FDD operation in different time slots of equal length (τ);

FIG. 10 shows an example of radio network components, auxiliary systems that can be shared between operators when time sharing radio frequency spectrum Fs;

FIG. 11 illustrates an example embodiment of a network node;

FIG. 12 illustrates another example embodiment of a network node;

FIG. 13 illustrates an example embodiment of a wireless device; and

FIG. 14 illustrates another example embodiment of a wireless device.

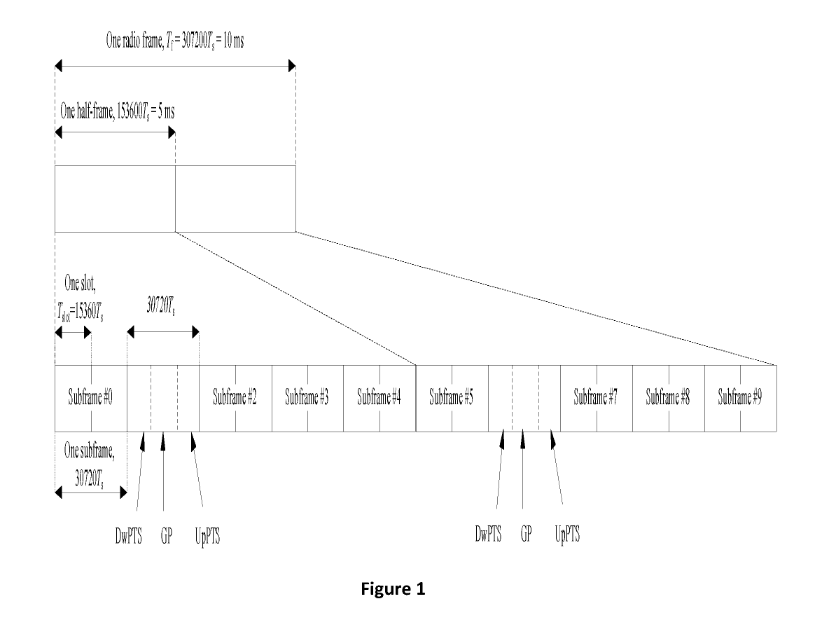

### DETAILED DESCRIPTION OF NON-LIMITING EXAMPLE EMBODIMENTS

The technology will now be described more fully hereinafter with reference to the accompanying drawings, in which certain embodiments are shown. The technology may, however, be embodied in many different forms and should not be construed as limited to the embodiments set forth herein; rather, these embodiments are provided by way of example so that this disclosure will be thorough and complete, and will fully convey the scope of the technology to those persons skilled in the art. Like reference numbers refer to like elements or method steps throughout the description.

Terminologies from 3GPP are used herein only to facilitate explanation and example application. Wireless systems such as WCDMA, WiMax, UMB, GSM, WiFi, LTE and others may benefit from the technology described herein

In one or more aspects, a common part of a radio spectrum is shared between multiple (i.e., two or more) operators to perform their respective radio communications between their radio network and wireless devices over their allocated disjoint (i.e., non-overlapping) time periods.

The shared frequency spectrum Fs can comprise portions of the radio spectrum allocated to one or more operators. An operator may share some, none, or all of its allocation. The shared spectrum Fs in its entirety can be from a single operator or from multiple operators.

Each donating operator need not participate in the time sharing and each sharing operator need not donate. It is only necessary that there is a frequency spectrum Fs that is time shared by two or more operators.

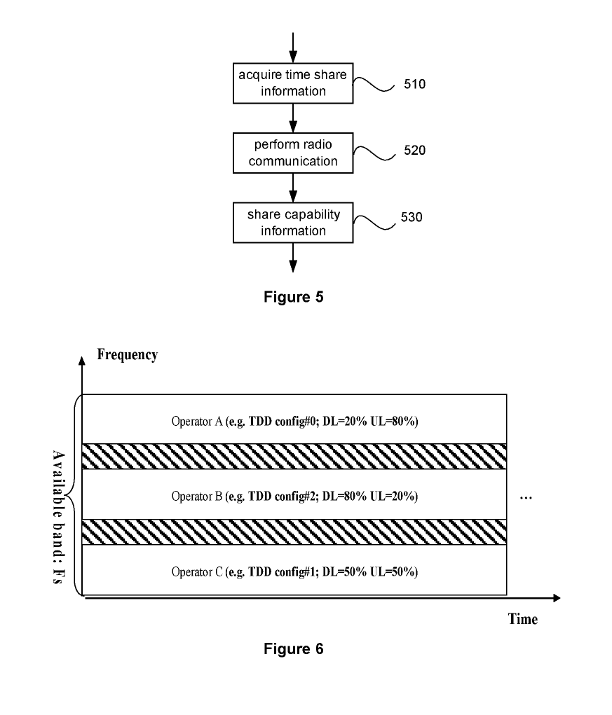

As illustrated in FIG. 5, in order to realize inter-operator time sharing of spectrum Fs, network nodes and wireless devices may implement methods to:
Acquire information related to time sharing of radio spectrum (act 510); and
Perform radio communication based on the acquired information (act 520).

While not strictly required, information related to capabilities of the network and radio nodes and wireless devices may be shared (act 530) to facilitate the time sharing operations.

In one aspect, one or more radio nodes may execute a method to perform a radio communication with a wireless device. In this method, one or more radio nodes may determine at least a first time period and a second time period, where the first and the second time periods are non-overlapping in time. Also, one or more radio nodes may share a common part of a radio spectrum for performing a first radio communication over the first time period, and a second radio communication over the second time period. The first radio communication can be associated with at least one type of cell identifier that is different than the same type of cell identifier associated with the second radio communication.

A first radio node may perform the first radio communication and a second radio node may perform the second radio communication. Alternatively, a single radio node may perform both the first and second radio communications.

In another alternative, the first and the second radio communications may be performed by using one or more parts of the first and the second radio nodes respectively and by sharing the remaining one or more parts of the first or the second radio nodes. In this alternative, one or more parts of the first or the radio nodes that are shared or that are not shared may comprise of any one or more a radio frequency unit, a baseband processing unit, a radio resource management unit, and a resource assignment unit.

The first and the second radio communications may be respectively associated with first and the second public land mobile network (PLMN) identifiers, which in turn may be respectively associated with the first and the second operators. The cell identifier can be, among others, at least one of a physical cell identifier, a cell global identifier, and a scrambling code.

One or both of the first and the second time periods may comprise at least one radio frame. Also, one or both of the first and second time periods may be determined based on one or more of the following:
the first and the second time periods may comprise K and L consecutive radio frames respectively, where K≧1 and L≧1; and
M number of the first time periods and N number of the second time periods are comprised in a sequence pattern, where M≧1 and N≧1 and the length of the pattern is at least the sum of the M first and N second time periods.

The sequence pattern may be associated with one or more of a periodicity of the pattern, a starting reference time of the pattern, and a guard time between at least the first and the second time periods. The radio nodes (e.g., single, first, second) may determine the first and the second time periods and/or the pattern based on one or both of a predefined rule and a configuration performed by a another node, e.g. a configuring node. Examples of the configuring node include, among others, any of the radio nodes (e.g., single, first, second), a radio network controller, a base station controller, a core network node, an O&M node, an OSS node, and a SON node.

The first radio communication can be performed over the first time period over various operation modes including, among others, time division multiplex (TDD), frequency division duplex (FDD), half duplex FDD (HD-FDD), and DL FDD. Similarly, the second radio communication can be performed over the second time period over various operation modes including, among others, TDD, FDD, HD-FDD, and DL FDD. When the operation mode of the first radio communication is TDD, the TDD configuration may be predefined. When the operation mode of the second radio communication is TDD, the TDD configuration may be predefined.

Each of the single radio node, the first radio node, and the second radio node can be any one of a radio base station, a relay, eNode B, Node B, a multi-standard radio network node, and a wireless access point among others.

In another aspect, a wireless device may execute a method to perform a radio communication. In this method, the wireless device may determine at least a first time period and a second time period, where the first and the second time periods are non-overlapping in time. Also, the wireless device may perform a first radio communication over the first time period over a common part of a radio spectrum which may be shared with a second radio communication performed over second time period. The first radio communication may be associated with at least one type of cell identifier which is different than the same type of cell identifier associated with radio communications other than the first radio communication.

The radio communication may include transmitting and/or receiving signals between the radio node and the wireless device. A first wireless device may perform the first radio communication with a first radio node, and a second wireless device may perform the second radio communication with a second radio node. Alternatively, a single wireless device may perform the first radio communication with the first radio node, and perform the second radio communication with the second radio node. The wireless devices (e.g., single, first, second) may determine the first and the second time periods and/or a pattern of sequence based on one or both of a predefined rule and a configuration performed by a configuring network node.

In yet another aspect, a network node may perform a radio communication method. In the method, the network node may acquire time share information related to a shared spectrum Fs, which is time shared by first and second networks respectively operated by first and second operators.

The time share information may include one or more parameters that identify the shared spectrum Fs and one or more parameters that identify a plurality of time periods corresponding to a plurality of operators that are time sharing the shared spectrum Fs. The plurality of operators may include the first and second operators, and the plurality of time periods may include first and second time periods. The first time period may be a time period in which the shared spectrum Fs is exclusively assigned for use by the first network, and the second time period may be a time period in which the shared spectrum Fs is exclusively assigned for use by the second network.

A further method comprises performing, based on the time share information, a first radio communication by a first radio node in the first time period. The first radio communication may be a radio communication between a first radio node and a first wireless device being served by the first network. The method may further include performing, based on the time share information, a second radio communication by a second radio node in the second time period. The second radio communication may be a radio communication between the second radio node and a second wireless device being served by the second network.

The time share information may also include one or more parameters that identify a plurality of cell identifiers associated with a plurality of radio communications during the corresponding time periods including first and second cell identifiers associated with the first and second radio communications during the corresponding first and second time periods.

The network node, the first radio node, and the second radio node may all be implemented as different nodes. However, any two or even all three nodes may be implemented in a single node. Further, when the first and second radio nodes are not completely implemented in one node, the first and second radio nodes may share one or more common components.

In addition, time share capability information of the network node, the first radio node, and/or the second radio node may be forwarded to each other, to other network nodes, and/or to the first and/or second wireless devices.

In a further aspect, a wireless device may perform a radio communication method. In the method, the wireless device may acquire time share information related to a shared spectrum Fs, which is time shared by first and second networks respectively operated by first and second operators. Contents of the time share information may be as described above.

The wireless device may perform, based on the time share information, a first radio communication in a first time period, which may be a time period in which the shared spectrum Fs is exclusively assigned for use by the first network. The first radio communication may be a radio communication between the wireless device and a first radio node.

The same or a different wireless device may perform, based on the time share information, a second radio communication in a second time period, which may be a time period in which the shared spectrum Fs is exclusively assigned for use by the second network. The second radio communication may be a radio communication between the wireless device (same or different) and a second radio node.

Generally, multiple operators may use the shared frequency spectrum Fs over different time periods. During each time period, the entire, or same, shared Fs band is assigned to that operator. Each operator thus uses the shared Fs for radio communication over its allocated time period, which may recur with a repetition time depending upon the assignment principle. As will be described further below, the time share approach also enables the operators to share fully or partly the radio network equipment. The approach further enables the operators to offer increased peak rates.

Aspects of the technology described in this disclosure can include, among others:
Method/apparatus/system of time sharing of spectrum between operators;
Method/apparatus/system of acquiring time sharing related information;
Method/apparatus/system of sharing network components for radio communication in time sharing manner;
Method/apparatus/system of signaling radio node and wireless device time sharing capabilities to other nodes;
Method/apparatus/system of forwarding the time sharing related information to other network nodes, e.g., for network management;

The disclosed aspects address one or more problems associated with prior art systems mentioned above. Note that some or all aspects are applicable for operations involving any of the duplex modes (e.g., TDD, FDD, HD-FDD, DL FDD band, etc.) unless explicitly stated otherwise.

### TERMINOLOGIES

The following terminologies which are extensively used in this disclosure are described below:
Wireless device: There are several different kinds of wireless devices or user equipments (UE) in terms of different technical and brand names, application scenarios (e.g., USB-dongle, target device), mobile terminal, wireless terminal, wireless terminal used for machine type communication (e.g., M2M communication), wireless device used for device to device communication, and so on. The embodiments are applicable to any type of wireless device or UE;
Radio node: A radio node, also interchangeably referred to as a radio network node, serves wireless devices (e.g., UE) in a cell or in a coverage area by receiving and/or transmitting radio signals. The radio node maintains a radio communication link between itself and at least one wireless device. Examples of radio nodes include eNodeB, BS, NodeB, donor eNodeB serving relay, donor BS serving, relay node, a multi-standard (MSR) radio node, multi-RAT BS, location measurement unit (LMU) among others;
Network node: A network node can be a radio node as described above or any other type of nodes of the network. The network node may communicate with the radio node. The network node may also communicate with a wireless device (e.g., UE) using higher layer signaling. The network node need not directly maintain a radio communication link with the wireless device. The network node however may still communicate with another radio node over a wireless communication link. In addition to radio nodes, examples of network nodes include RNC, BSC, core network node, SON, OSS, O&M, network planning and management node, network monitoring node, positioning node among others.

Unless otherwise indicated, network node should be broadly interpreted to include the radio node.

### Inter-Operator Time Sharing of Spectrum

Consider a part of a radio spectrum or a frequency band which is available for radio communication between a radio node and a wireless device. Generic terms such as radio spectrum and radio communication can be used. The terms band, frequency band, radio frequency, radio spectrum are interchangeably used and can be viewed as bearing the same meaning. Similarly radio communication includes other well known terms like wireless communication, mobile communication, cellular communication etc.

In this disclosure, the notation Fs will be used to refer to the radio spectrum shared by multiple operators. Preferably, the shared spectrum Fs is comprised of adjacent carriers, i.e., carriers that are adjacent to each other in the frequency domain, or at least close to each other in frequency. One or more of the disclosed aspects are particularly beneficial when the shared carriers are adjacent. However, this is not a requirement. The shared spectrum Fs can comprise multiple frequency chunks at least two of which are not adjacent. The shared spectrum Fs can be called by different terminologies including, among others, time shared spectrum (TSS), time shared frequency spectrum (TSFS), time shared frequency band (TSB), inter-operator shared spectrum, inter-operator shared frequency band, inter-operator time shared frequency band, and inter-operator time shared spectrum. Some or all disclosed aspects provide benefits even when shared carriers are not all adjacent carriers.

FIG. 6 shows an example assignment of radio spectrum Fs by splitting it equally among three different operators using conventional technique, where TDD operation requires guard band and/or restricted block between carriers. FIG. 6 thus illustrates an example scenario in which an available radio spectrum is divided into three equal portions or chunks and the chunks are allocated to three operators A, B and C. Note that the allocation need not necessarily be equal. The horizontal axis represents time and the vertical axis represents frequency. As seen, each operator uses its allocated chunk continuously in time.

It is assumed that each operator uses a TDD configuration different from other operators, i.e., they are not synchronized. According to the conventional principle, unsynchronized TDD requires each operator to devote a part of its allocation for a guard band. As a result, not all of the available spectrum is used for communication.

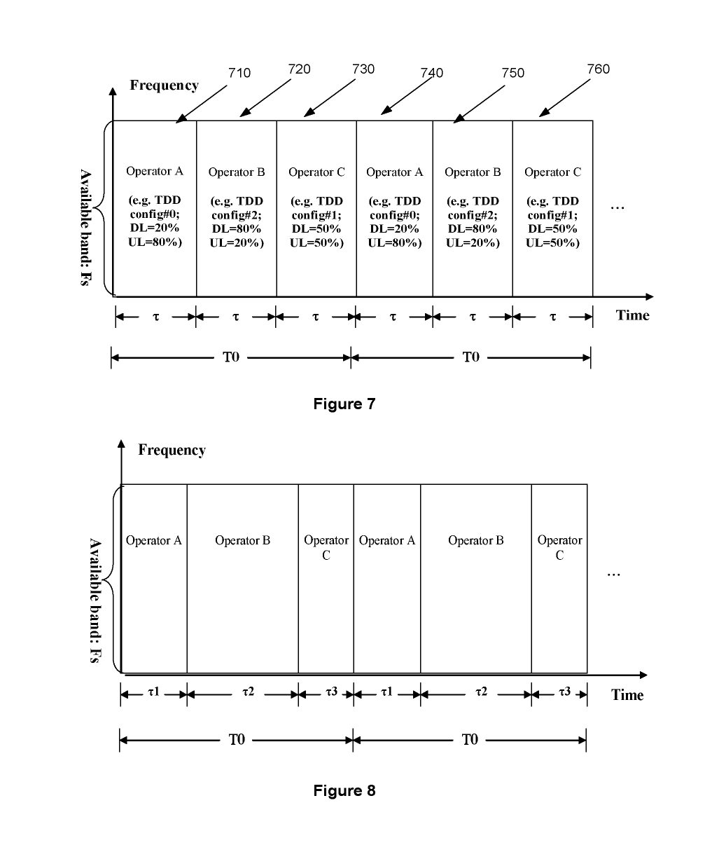

However, in an aspect of the technology proposed herein, the available spectrum is instead time shared among the operators as illustrated in FIG. 7. FIG. 7 illustrates a time sharing example, where an entire, or same, available spectrum Fs shared by operators for TDD operation in different time slots of equal length (τ). In other words, a same frequency spectrum Fs is allocated to each operator of a plurality of operators (here operators A, B, and C, respectively) during different time periods such that the same frequency spectrum Fs is shared among the plurality of operators. As can be seen in FIG. 7, the frequency spectrum Fs can be allocated to a first operator (e.g. operator A) during a first time period 710. The same frequency spectrum can be allocated to a second operator (e.g. operator B) during a second time period 720, which is subsequent to the first time period 710. Also, the same frequency spectrum can be allocated to a third operator (e.g. operator C) during a third time period 730, which is subsequent to the second time period 720

The figure further shows that each operator (i.e., its network nodes and/or wireless devices) can use the entire spectrum Fs over a time period τ, which occurs periodically once every T0. Thus, in this example, the same frequency spectrum Fs can be allocated to the first operator (e.g. operator A) during a fourth time period 740, which is subsequent to the third time period 730. Also, the same frequency spectrum Fs can be allocated to the second operator (e.g. operator B) during a fifth time period 750, which is subsequent to the fourth time period 740. Also, the same frequency spectrum can be allocated to the third operator (e.g. operator C) during a sixth time period 760, which is subsequent to the fifth time period 750.

The time sharing approach enables each operator to use its own preferred TDD configuration during its assigned time period. As shown, operators A, B and C can use TDD configurations 0, 2 and 1, respectively, during their respective assigned time periods.

It is seen that with the time sharing aspect, the entire, or same, shared spectrum Fs can be used (i.e., no guard bands are required) while allowing each operator to freely implement its preferred TDD configuration. While not shown, the same operator can also use different TDD configuration in different occurrences of its assigned time periods. Each operator can therefore use any TDD configuration, which is suited to its traffic demand, during its assigned, or allocated, time periods.

As an alternative, the time periods assigned to operators can be unequal in length as illustrated in FIG. 8. The operators A, B and C can use the full spectrum Fs over time periods τ1, τ2 and τ3, respectively, during an aggregated duration of T0.

During the assigned time period, the operator's radio node may be required to switch ON its receiver and transmitter during the DL and UL subframes respectively or during a special subframe in TDD. Similarly, the operators' radio nodes during their unassigned time periods may be required to switch OFF their transceivers to prevent interference to the allowed operators. Thus, an inter-operator guard time (or simply guard time) between the time periods assigned to different operators may be specified to avoid interference or signal disruption.

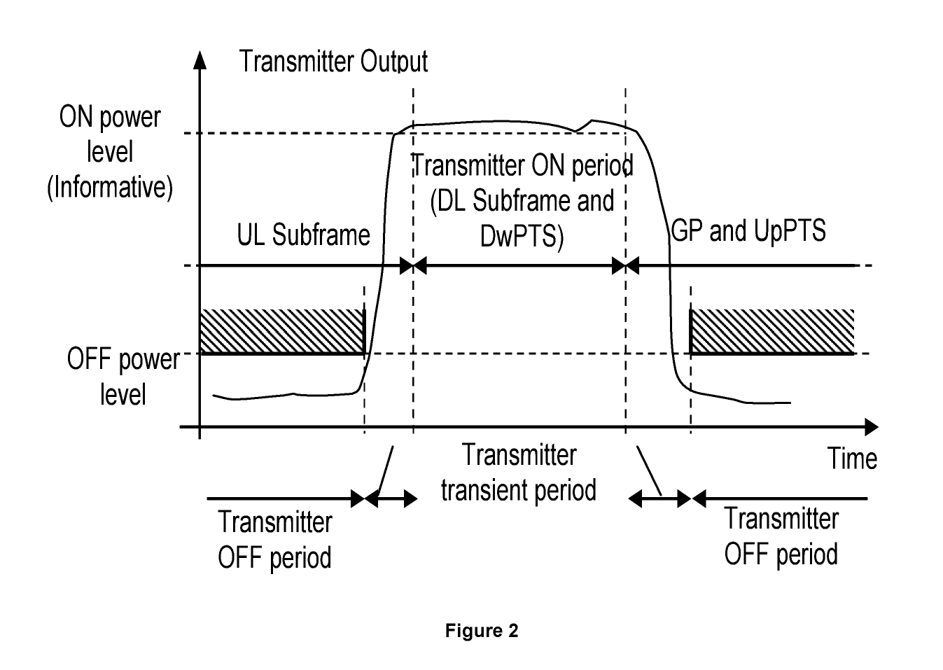

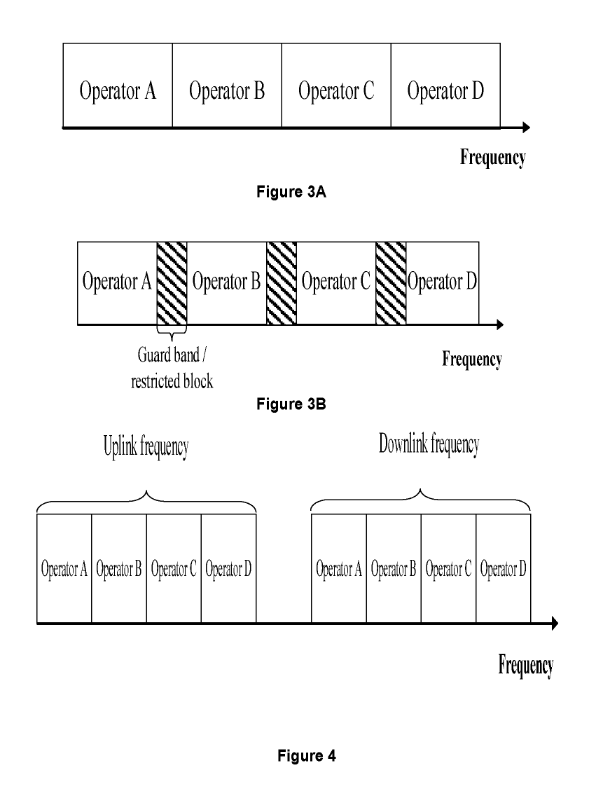

If specified, the available spectrum Fs is not used during the guard time. However, this is much more preferable when compared to the resources made unusable by the guard bands of the conventional technique. This is because the transition from OFF to ON state can generally be very short. Referring back to FIG. 2, recall that the transient period to switch between a radio transmitter ON and OFF states in a radio node (e.g., base station) is merely 17 μs or even shorter such as 3-5 μs.

As an demonstration, assume that in FIGS. 6 and 7, the time period τ is 10 ms (for a single radio frame) long and that the shared spectrum Fs is 50 MHz wide, and each guard band is 5 MHz wide. With the conventional technique of FIG. 6, the unusable bandwidth amounts to 10 MHz or 20%. But with the time sharing approach and assuming that the transient period is 17 μs, the unused time is miniscule.

It is noted that in the UE, the switching time for the radio transmitter may be longer e.g., in the order of 100-500 μs. When a worst case of 500 μs is assumed, the unused time amounts to five percent. This is still much better than the conventional technique. If the time is lengthened to 100 ms (then radio frames), then the unused time could be reduced to less than one percent.

Moreover, the effects of finite transition time can be further mitigated, at least to some extent reduced, by starting the transition from OFF to ON prior to the beginning of the assigned time period. For example, if the guard time is specified to be 100 μs, the UE transition can be initiated 400 μs prior to the start of the assigned time period. Then for the single radio frame long time period τ, the unused time is reduced to one percent. The radio node can also initiate early transition. However, since the transition is so short at the radio node, the benefit will not be as great.

If the transition is started prior to the assigned time period in the UE and/or in the radio node, care should generally be taken so that any interference caused during the unassigned time periods is minimized.

Note that if the RF components of the radio node are shared between two operators and their assigned time periods are consecutive, this can remove the need to adhere to the guard period.

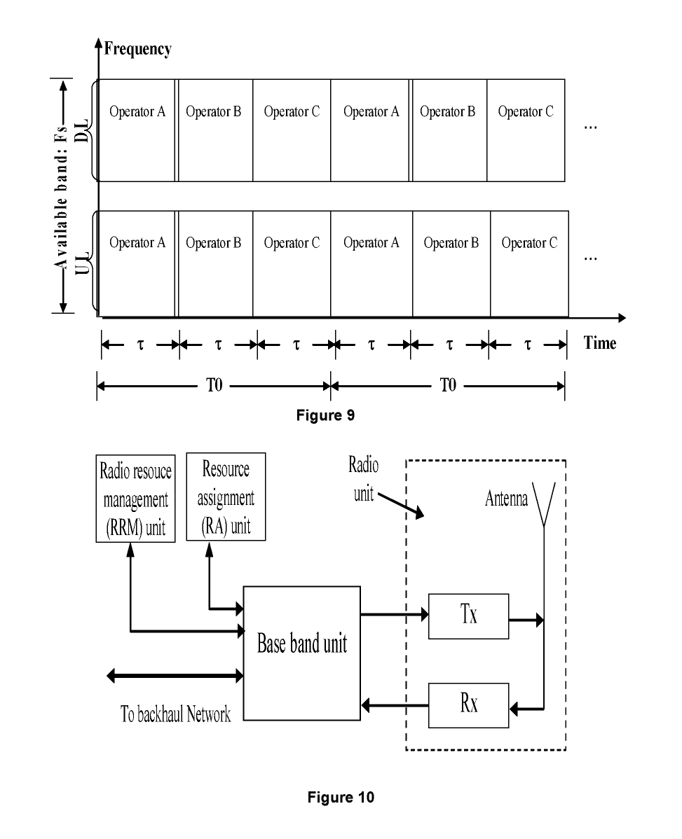

An example time sharing in FDD is illustrated in FIG. 9. In FIG. 9, the available spectrum Fs is split into two parts for UL and DL transmissions. In this example, each operator (i.e., its radio nodes and wireless devices) can use the entire UL and DL parts of the shared spectrum Fs over a time period τ, which like in the TDD examples, also occurs periodically once every T0. While not shown, spectrum Fs can also be assigned for unequal time periods (e.g., over τ1, τ2 and τ3 for operators A, B and C respectively).

As will be appreciated, the time sharing principle can be applied on the UL frequencies, on the DL frequencies, or on both. The time sharing may also be combined with half duplex operation. For example, during the assigned time period, the network can use half duplex meaning that the UL and DL transmissions take place on different frequencies but not simultaneously.

In another aspect, different time periods can be allocated for DL and UL frequencies of the same band to different operators. For example operators A, B and C can be assigned time period τ1_ul, τ2_ul and τ3_ul respectively for the UL spectrum and τ4_dl, τ5_dl and τ6_dl for the DL spectrum.

Guard times between the time periods assigned to different operators can be used to avoid interference or signal disruption due to transition between switching ON and OFF of the radio transceiver is also applicable to FDD or HD-FDD systems.

Network nodes and wireless devices involved in radio communication can acquire the relevant information (e.g., values of parameters) related to the time shared radio spectrum Fs and use them to perform radio communication between the network and the wireless devices.

The following list includes some of the basic parameters that should, or could, be acquired to enable inter-operator time sharing of radio spectrum:
Radio spectrum Fs to be time shared between at least two operators:
   E.g., predefined band indicator or number, carrier frequency numbers or radio channels (e.g., ARFCN). For example, it can be predefined that a particular band with a certain band indicator and/or channel number(s) can be operated using time sharing of Fs. A band indicator and ARFCN are typically unique. As an illustration, if the existing TDD band 38 (2.6 MHz) is standardized for use as “a time shared band” in future, then new band indicator (e.g., band 50) and new ARFNC ranges will be defined. Therefore new predefined band indicator and/or set of ARFCNs will enable the radio node and/or the wireless device to recognize a band which uses time sharing of the radio spectrum.
Time periods Tᵢ assigned to operator i, where i≧2:
   Tᵢ can be integer multiple of radio frames;
   Tᵢ can be expressed percentage allocation e.g., 33.3% of time assigned to each of the 3 operators;
   Details of their usage may be up to the operators.
Periodicity of occurrence T0 of the assigned time periods Tᵢ;
A cell identifier associated with radio communication during an assigned time period, which can distinguish between different operators sharing the same spectrum. Existing cell identifier could be used.

Examples of existing cell identifiers include, among others, physical cell identifier (PCI), cell global identifier (CGI), and scrambling codes. The PCI are limited and are therefore reused (504 PCIs available in LTE, 512 in HSPA). The PCIs are transmitted in physical signals like synchronization signals and cell specific reference signals, i.e., in physical layer. The CGI is unique in the entire network, but are transmitted in a higher layer signaling, and thus may require reading of master information blocks (MIB) and system information blocks (SIBs).

A cell can be uniquely identified by a cell identifier and frequency. To distinguish signals from different operators using the same frequency (as in time sharing of Fs), at least one type of cell identifiers (e.g., PCI) during the assigned time periods should be unique. For example during τ1, τ2 and τ3, the operators A, B and C may use PCI1, PCI2 and PCI3, respectively. In this way, the wireless device during initial access or during cell identification can distinguish between the signals from different operators.

The following list includes some additional parameters that could be acquired to enable or further enhance the inter-operator time sharing of Fs:
Number of consecutive radio frames within a time period assigned to each operator—can be the same or different for different operators;
Inter-operator guard time to account for transition due to switching between transceiver ON and OFF when changing between time periods belonging to different operators (e.g., 100-500 μs);
A pattern of assigned time periods to different operators—the pattern can comprise one or more of the following parameters:
   Whether pattern is periodic or aperiodic;
   Number of time periods assigned to different operators during the pattern;
   Pattern length:
      Should be at least a sum of the number of time periods assigned to different operators;
      If specified, account for guard times;
   Pattern periodicity after which it repeats
      In case of periodic pattern, should be equal to the pattern length;
   Starting reference time of the pattern (e.g., SFN, absolute time, a time obtained from a global reference clock (e.g., GNSS));
   Duration over which the pattern is applicable (e.g., infinity, one hour, several periods, several frames);
   TDD configuration (UL/DL and/or S subframe configuration) for each operator in each time period—applicable to TDD operation.
   Number and identifiers of UL and/or DL subframes used in a frame in case of HD-FDD operation—applicable to HS-FDD operation.

The time sharing parameters may be associated with each radio spectrum (i.e., frequency bands). This means that some parameters may be different for different bands. However, some or all the parameters may be common for certain bands e.g., bands in certain frequency ranges such as between 2-2.5 GHz. The parameter values may also depend upon the duplex mode (TDD, FDD, HD-FDD, DL FDD, etc.)

### Acquiring Time Sharing Related Information

A network node (including radio node) intending to use the radio spectrum for radio communication can acquire the time sharing related information (e.g., basic and additional parameters) based on one or both of the following:
Predefined rule; and
A configuration performed by a configuring network node.

In one aspect, some or all parameters may be predefined in the network node. For example, at least some of the basic parameters (such as time periods, percentage of time assigned to each operator, periodicity, inter-operator guard time and so on) can be predefined. This can be done at the time of assigning the spectrum to operators, e.g. when initiated by regulators.

The predefined assignment can also be revised over time in case new operators who want to access the same radio spectrum are introduced or the existing operators want to change their allocated time periods or if the spectrum is modified. The predefined time sharing information can be stored in the network nodes in accordance with the predefined rules.

In another aspect, the network node may acquire the necessary time sharing information from another network node, i.e., a configuring node. Configuring node examples include OSS, O&M or SON nodes. The configuring node may configure the network nodes (e.g., eNB, NodeB, RNC) with the required time sharing parameters associated with a particular radio spectrum or a frequency band. In yet another example, network node such as core network node or a radio node (e.g., RNC or BSC) may configure another radio node with the time sharing related parameters.

The configuring node may determine the values of the parameters based on predefined or stored information. The information can be modified over time in case one or more parameters change over time, spectrum is reframed or modified, new operators acquire the spectrum or the existing operators relinquish their spectrum, etc. Alternatively or additionally, the parameter values can be determined based on input received from other operators e.g., via their respective configuring nodes.

The configuring node can be distributed i.e., be unique for each operator. Alternatively all or a group of operators may share the same configuring node for configuring the time sharing parameters associated with one or more radio spectrum or bands. The latter approach would simplify coordination between operators.

In yet another aspect, principles described above can be combined by the network node to acquire the necessary, or otherwise important or relevant, time sharing related parameters. In one example, the basic parameters (e.g., time periods or percentage allocation of spectrum) may be acquired based on predefined information, and additional parameters may be acquired from the configuring node or any other network node.

A wireless device (e.g., a UE) also needs to be aware of the time sharing, and thus should also be aware of some or all of the basic and/or additional parameters. The wireless device can acquire the time sharing related information based on one or both of the following:
Predefined rule; and
Information received from the network.

Some or all parameters may be predefined in the wireless device. More realistically however, a wireless device capable of supporting time sharing of radio spectrum (e.g., band X) may store some minimum information related to time sharing. The stored predefined information can include, among others, band indicator, number of operators sharing spectrum, part of spectrum or its ARFNC ranges to be shared among operators in time, time allocation or time period assigned to each operator.

The wireless device may also acquire from the predefined information that each operator uses at least one full radio frame during its assigned time period or that the time period for each operator includes at least one radio frame. The wireless device may also determine from the predefined information that each operator uses at least one type of distinct cell identifier (e.g., different PCI) in their respective allocated time period in their network or at least in the same geographical area or region or in a coverage area. A physical size of an area in which a particular cell identifier is to be unique among operators may also be predefined.

The distinct cell identifier enables the wireless device to distinguish between different operators at least during initial access, cell identification or prior to starting the radio communication with the network. In order to ensure flexibility, the exact cell identifier such as PCI to be used in order to distinguish signals from different operators may not be predefined.

The wireless device may store the predefined information in a memory in the wireless device or otherwise easily accessible such as on a SIM, USIM. Preferably, the memory can be easily overwritten by an operator or subscriber or through an application program downloaded via a computer. This approach of using SIM card or any rewritable memory is particularly flexible to operators as it enables them to change their time allocation in future due to change in their traffic demand or due to other reasons such as the inclusion of new operators, the existing ones quitting the band allocation or assigning their allocation to other operators.

Alternatively, the network node can signal time sharing related information and parameters for each radio spectrum or band described above to the wireless device. The information can be signaled on cell specific channel (e.g., broadcast information such as in MIB and SIBs) for the wireless device in low activity state (e.g., idle state, URA_PCH, CELL_PCH, CELL_FACH states). Additionally, or alternatively, the time sharing information can be signaled over a specific channel (e.g., dedicated control channel (DCCH)) to the wireless in the connected state. The DCCH can be transmitted over a shared channel such as PDSCH in LTE.

The network may signal the time sharing information related to the radio spectrum or frequency band used for conveying this information as well as of other time shared frequency bands. The wireless device capable of multiple time shared frequency bands can therefore acquire time sharing information related to one or plurality of its supported time shared frequency bands. In one embodiment, certain specific parameters or all basic parameters, some of which can be initially predefined, may also be signaled by the network e.g., number of operators sharing spectrum. This may facilitate neighbor cell identification of cells on bands for which UE may not have updated predefined information.

A subset of time sharing parameters may be specific to a cell or group of cells. In other words, the values of certain parameters may be different depending upon the coverage area. For example consider a scenario in which three operators A, B and C agree on different time allocation in different sites but overall their share is the same e.g., equal split or 33.33% in time on average. In another example, the same operator may use different TDD configuration in different cells during its allocated time period for a particular band.

The inter-operator guard time may be different in different cells or in coverage areas. Therefore a cell (serving cell or a reference cell) may also signal to the UE at least certain time sharing parameters for neighboring cells. The neighbor cells whose time sharing related information is signaled may belong to the intra-frequency spectrum or band (i.e., same frequency as that of the serving cell), inter-frequency or even inter-RAT spectrum or band. The wireless device may acquire certain remaining information from another wireless device in case it is device-to-device capable.

In another alternative, the principles described above can be combined by the wireless device to acquire the necessary time sharing related parameters. In one example, the basic parameters (e.g., time periods or percentage allocation of spectrum) may be acquired based on predefined information, and additional parameters may be acquired from the network. The wireless device may even acquire certain remaining information from another wireless device.

As an illustration, the wireless device may use basic predefined information to perform initial cell identification (cell search) of a cell operating on a time shared spectrum and acquire the remaining or additional parameters after camping on or connecting to the identified cell.

### Sharing of Equipment in Inter-Operator Time Sharing of Frequency Spectrum

Referring back to FIGS. 7, 8, and 9, note that during the assigned time period (e.g., during τ in case of equal time split or τ1, τ2 and τ3 otherwise), each operator can use its radio network equipment to perform radio communication. However, the inter-operator time sharing of Fs can also allow operators to partly or even fully share radio network equipment and potentially even wireless devices. This can save costs and reduce deployment efforts.

During its respective assigned time period, each operator may use the shared spectrum Fs for radio communication between its network and one or more wireless devices. In one aspect, two or more operators that are time sharing the same spectrum Fs may also share or reuse the entire radio network or parts or components of the radio network equipment during their respective assigned time periods for their respective radio communication.

FIG. 10 shows an example of an architecture of radio network equipment and auxiliary systems which can be shared between two or more operators during their respective time periods. Preferably, the entire radio node is shared. For example, an entire base station, including radio and baseband parts, located at a site can be shared among the three operators A, B and C. It is also possible to share parts of the radio node.

The operators may share any one or more of:
Radio unit (RF components) which typically includes a transceiver and antennas;
Base band unit which typically performs signal processing related tasks such as modulation of the signals prior to transmission via radio device over a radio interface and demodulation of signals after reception by the radio device;
Radio resource management (RRM) unit which typically performs tasks such as management of the measurement configuration for UE in idle and connected states, and mobility decisions such as cell change in idle and connected states;
Resource assignment (RA) unit which can perform tasks such as UL and DL power control (power allocation to transmission of signals from UE and radio nodes), issuance of scheduling grant, link adaption, scheduling of UL and DL data, and management of UE resource request.

Note that each component can be implemented in software, hardware, or a combination of software and hardware. The shared network equipment can be implemented in hardware, at least in part.

The architecture of the radio network equipment and auxiliary systems may be such that certain components or devices may be located in the same node (e.g., eNodeB). In another example, certain devices or functions like RRM unit may be located in a controller such as in RNC, whereas the remaining devices/functions may be located in separate node like in NodeB. Sharing of the network equipment or of any auxiliary devices between operators is applicable to many different types of architectures. The partial or full sharing of equipment can be done at specific sites, in part of the network (e.g., in a city center) or in the entire network or coverage area.

Preferably, the sharing between operators for radio communication is made in both directions—for reception in UL and transmission in DL. However, the sharing can be in one direction only. Also, different parts can be shared in DL than in UL. It is also possible that certain some components like radio unit are shared in one direction whereas other parts like base band unit are shared in the other direction.

The components and units to be shared between operators for performing radio communication during their respective time periods can be predefined, can be configured (e.g., a configuring node), or can be a combination thereof. The sharing may be predefined during which time periods certain components are used and also the direction (for UL, for DL or for both UL and DL). When predefined, the information can be stored in the radio node whose components or auxiliary systems are to be shared between operators.

Alternatively such information may also be stored in the actual components to be shared between the operators. In cases where sharing is triggered by configuration, the radio node or the components to be shared can receive an instruction from the configuring node, which can store the sharing information related to different operators. The instruction can be sent at the time of initial setup of the radio node, during maintenance of the radio node, or when there is any change in the configuration.

This can pave a way for new operators to start radio communication services with partial deployment or even without any physical deployment of radio network hardware equipment. Network sharing can reduce deployment cost, operation cost, energy cost. This can also reduce emissions of pollutants such as CO2 (carbon dioxide) since overall energy consumption is reduced.

Wireless devices could also be shared. When a wireless device is more or less stationary, it can be used to perform radio communications associated with different operators in time sharing manner during their respective allocated time periods. For example, the same wireless device can be connected via local links (e.g., fixed or wireless) to different users' terminals and to their basic accessories such as key board, key pad, and touch screen. The wireless device can thus serve users by establishing radio communication with the relevant radio network nodes during the time periods allocated to their respective operators or service providers.

Time sharing of a wireless device could also be used for M2M (machine-to-machine) communications. For example, two or more operators during their allocated time periods may use the same wireless device to obtain the measurement results related to usage of utilities services such as electricity and water from their respective subscribers.

Similar to the time sharing of radio network components, the time sharing of wireless device between operators can also be based on a predefined rule, be network configured (e.g., by a configuring node), or a combination thereof. For example, the wireless device time sharing may be predefined during which time periods certain components (e.g., radio unit, base band unit, both) are used and also the direction of radio communication in which it is used (for UL, for DL or for both).

The configuring node can be a radio node (e.g., serving eNB, base station, RNC, BSC etc). Other configuring nodes (e.g., SON, OSS, O&M etc) may, via the radio node or through higher layer signaling, configure the wireless device for the time shared radio communication.

### Signaling Time Sharing Capabilities

The same frequency band or part of radio spectrum may be specified to be used in a classical manner (i.e., split of spectrum between operators in frequency) or in a time sharing manner between operators as described herein. In one country or region, a frequency spectrum in the range of 2.6 GHz may be allocated to two or more operators by splitting it in frequency. But in another country or region, the same part of the spectrum or band may be allocated to two or more operators in time sharing manner over their respective time period or percentage of time. Due to the differences, the radio node and/or wireless devices may not support capabilities related to the time sharing of a radio spectrum in all regions.

A particular wireless device may be capable of supporting a certain radio spectrum or band but may not be capable of performing the radio communication using the same spectrum with the time sharing principle. Similarly, some radio nodes may not be capable of time sharing of a radio spectrum. That is, even if a wireless device and/or a radio node is capable of time sharing of a radio spectrum, it may or may not support sharing of their components for radio communications related to different operators.

Lack of capability information (i.e., whether or not the radio node and/or the wireless device can support time sharing of spectrum) can hinder the network from executing the appropriate procedures related to the inter-operator time sharing the radio spectrum for the purpose of radio communication between the network and the wireless device.

Thus, in one aspect, the radio node can signal to other nodes (e.g., other radio nodes, network nodes) whether or not it is capable of performing radio communication using time shared radio spectrum. Recall that time sharing of spectrum can be viewed as using the same part of the radio spectrum or frequency band for radio communication associated with at least two operators over two different or distinct time periods. The signals of radio communications of different operators can be distinguished by at least one type of distinct cell identifiers.

The radio node capability information may include one or more of the following that indicate whether the radio node is capable of supporting time sharing radio spectrum for radio communication:
in any frequency range;
associated with specific frequency ranges (e.g., frequencies below 2 GHz) or frequency bands (e.g., specific predefined band numbers);
provided if it is shared not more than certain number of operators in time for their respective radio communications e.g., 4 operators;
provided if it is shared among certain range of operators in time for their respective radio communications e.g., 2-6 operators;
only in single RAT operation or on multi-RAT operation (e.g., MSR operation) for all or specific set of RATs.

The radio node capability information may also indicate whether it is capable of sharing its one or more components and/or auxiliary systems or unit of the radio node for radio communications in UL and/or in DL related to different operators during their respective time periods. For example an eNB may signal one or more parameters associated with its capability to another eNB over the X2 interface in LTE. In another example, the eNB may signal its capability to a positioning node (e.g., E-SMLC) using LPPa protocol in LTE. Similarly a base station may signal their capability to SON node, Node B may signal it to RNC in HSPA, and so on.

A target node receiving the capability information may use the received information to perform one or more radio operational tasks. Examples of radio operational tasks include, among others, determining whether to use a radio spectrum in a time shared manner (or not) for radio communication, selecting and configuring parameters associated with time sharing of the radio spectrum (e.g., guard time between time periods), determining whether or not to signal parameters associated with time sharing of the spectrum (see examples above) to a neighboring node, or determining whether or not to allow sharing one or more components for radio communications associated with different operators.

The radio node may send the capability information to another network node in any of the following manners:
Proactive reporting without receiving any explicit request from another network node (e.g., neighboring or any target network node);
Reporting upon receiving an explicit request from another network node (e.g., neighboring or any target network node):
   The request can be sent to the radio node by another network node anytime;
   The request can be sent to the radio node at any specific occasion such as during initial setup, when the radio node is upgraded (e.g., more radio unit or transceivers, number of antennas in a radio unit are increased, new antennas modes are deployed).
Periodic reporting which in turn can be triggered or initiated by any of the following mechanism:
   proactively by the sending node;
   in response to an explicit request received from another node;
   when certain predefined condition is met e.g., when one or more parameters or characteristics such as number of antennas, bandwidth etc are changed.

A wireless device that can support time sharing of frequency spectrum can inform a network node that is it is capable and the extent of its capability. The wireless device capability information may include one or more of the following additional information and parameters e.g., wireless device is capable of supporting capable time sharing radio spectrum for radio communication:
one all or subset of its supported bands;
for all or subset of supported RATs e.g., for HSPA and LTE;
in any frequency range;
associated with specific frequency ranges (e.g., frequencies below 2 GHz) or frequency bands (e.g., specific predefined band numbers);
provided if it is shared not more than certain number of operators in time for their respective radio communications e.g., 4 operators;
provided if it is shared among certain range of operators in time for their respective radio communications e.g., 2-6 operators;
on more than one carrier frequency (e.g., primary component carrier and at least one secondary component carrier) in carrier aggregation;
on more than one radio link in multiflow or CoMP scenario on a carrier;
on more than one carrier frequency (e.g., primary component carrier and at least one secondary component carrier) in a combined carrier aggregation and multiflow or CoMP scenario

The wireless device capability may also indicate whether it is capable of sharing its one or more components or units (e.g., RF, baseband or entire wireless device) for radio communications:
in UL and/or in DL related to different operators during their respective time periods;
in specific scenario or application e.g., for device to device communication, machine type communication, fixed wireless access with shared terminal for different users or subscribers;
for specific RAT etc., only for HSPA and LTE.

The capability information may also indicate whether wireless device can use predefined parameters, network signaled parameters or a combination thereof for performing radio communications using the time shared radio spectrum. The wireless device may report its capability to its serving network node (e.g., RNC in HSPA, eNodeB in LTE, BTS in GSM). It may also report the capability or certain parameters associated therewith to other nodes including core network node and positioning node (e.g., E-SMLC in LTE).

The acquired capability information may be used by the serving network node for taking one or more radio operation tasks or actions. Examples tasks include, among others, determining the RAT(s) to be used for time shared radio spectrum, and determining whether or not to signal specific parameters related to the time shared radio spectrum to the wireless device.

The wireless device may send the capability information to the network node in any of the following manner:
Proactive reporting without receiving any explicit request from the network node (e.g., serving or any target network node);
Reporting upon receiving any explicit request from the network node (e.g., serving or any target network node)
   The request can be sent to the wireless device by the network anytime;
   The request can be sent to the wireless device at any specific occasion such as during initial setup or after a cell change (e.g., handover, RRC connection re-establishment, RRC connection release with redirection, PCell change in CA, PCC change in PCC).

In case of proactive reporting, the wireless device may report its capability during one or more of the following occasions:
During initial setup or call setup e.g., when establishing the RRC connection;
During cell change e.g., handover, primary carrier change in multi-carrier operation, PCell change in multi-carrier operation, RRC re-establishment, RRC connection release with redirection.

### Future Legacy Nodes and Wireless Devices Operating in Overlapping Time Shared Spectrum

The same, i.e. the entire available radio spectrum or a part thereof, can be specified based on the existing spectrum assignment principle as well as based on the time sharing spectrum assignment principle as described throughout this disclosure. For example, existing TDD band 42 (3400-3600 MHz) can also be specified in future as a new band (e.g., band 60) for use as time shared radio spectrum. Alternatively, the same TDD band 42 may only be partly specified as a new band (e.g., band 61) for use as time shared radio spectrum. Regardless, a legacy wireless device supporting an overlapping band (band 42) will not recognize or operate in band 61 or 62. However, the wireless device supporting legacy band(s) may still do initial cell search in a fully or partially overlapping band(s) based on time sharing principles.

To prevent a legacy wireless device from unnecessary search in such scenario, new signaling and/or behavior can be specified at least for future wireless devices, i.e., compliant to the same releases (e.g. of 3GPP Technical Specifications) when time sharing principles are specified or to the future releases. For example, assume one or more new bands are specified using a time shared spectrum sharing principle in release 13 of 3GPP Technical Specifications. In this case, release 13 compliant wireless devices and also network nodes supporting frequency band(s) based on legacy principle may follow certain predefined principles and/or behavior based on configuration information from a network node to prevent, minimize or reduce performance degradation and/or power consumption. Examples of predefined rules, signaling and capability for such future legacy wireless devices and network node are disclosed below:

Some non-limiting examples of predefined rules are given below:
It may be predefined that if a wireless device cannot detect the same reference signal (e.g., PSS/SSS, CRS, RS) in each of X number of consecutive frames and/or over any X out Y consecutive frames and/or in X frames over time duration (DO), then it may assume that the band is not supported by the wireless device.
It may be predefined that if the wireless device cannot detect the same reference signal sequence (e.g., same PSS/SSS, same CRS, same RS, same pilots) in each of the X number of consecutive frames and/or in each of X out Y consecutive frames and/or in X frames over time duration (DO) and received signal quality of reference signals in each of X frames is within a threshold, then it may assume that the band is not supported by the wireless device.

The wireless device, upon fulfilling the above conditions, may adapt one or more procedures related to radio operation. For example, it may stop searching a cell operating that radio spectrum or band. This in turn may save its battery power and also allow it to search cells on other bands more efficiently.

Some non-limiting examples of signaling, which can be sent via broadcast channels (e.g., on SIBs for low activity wireless devices) and via wireless device specific signaling (e.g., shared channel, dedicated channel for wireless device in connected state) to wireless devices are given below:
The serving node (e.g., supporting overlapping band based on legacy spectrum allocation principles) can indicate to a wireless device that the same or part of radio spectrum is specified for using time sharing principle as well as legacy principles. Using the illustration above, it may be indicated that band 42 is also specified as a band based on time shared spectrum principle. If so specified, it may also be indicated whether it is fully or partially specified as a band based on time sharing principle.
The network node may, in addition to the information mentioned above, inform whether or not a fully or partially band based on the time sharing principle is used in the network. Further, the network node may signal the geographical location (e.g., latitude, longitude) of the coverage area where the overlapping band(s) is used or is expected to be used.

A wireless device supporting an overlapping band based on legacy principles (e.g., band 42 capable) may, upon receiving the above signaling, adapt its procedure to avoid degradation (e.g., avoid and/or reduce performing unnecessary search the overlapping band). The wireless device may stop searching that band (band 42) when it enters in an area indicated by the network in case wireless device is aware of its location (e.g., stored location, determined using another supported band). The wireless device may also apply or trigger one or more predefined rules described above when it receives an indication from the network.

Some future legacy wireless device and/or network node may not be capable of supporting the predefined rules, signaling and their compliance disclosed above. For example, wireless device and network node supporting certain bands may be compliant these rules and principles.

Accordingly, a wireless device supporting a band based on legacy spectrum allocation principle may signal its capability to a network node (e.g., eNode B) or to another wireless device (e.g., in D2D communication mode) indicating whether it is capable of adapting one or more procedure related to radio operation when the same radio spectrum is used based on the time sharing principle. The wireless device may even indicate whether it is compliant or not to one or more predefined rules and/or signaling disclosed above.

The network node may, upon receiving the capability information from the wireless device, forward it to another node, which may use the information e.g. after cell change of the wireless device. The network node may also use this information to determine whether or not to signal information and also the extent of the information that should be signaled.

### Forwarding Time Sharing Related Information

According to another aspect of the technology described herein, a network node (e.g., a eNB a NodeB, a BSC, a RNC) may forward certain information associated with time sharing of the radio spectrum Fs to other network nodes, which in turn may use the information e.g. for network management tasks. Examples of such information include one or more acquired parameters, parameters selected by the network itself and related to time sharing of radio spectrum, network and/or wireless device capabilities. The information may also be related to the statistics of wireless devices (e.g., number of users, throughput), operating in bands specified based on both legacy spectrum allocation principles (e.g., operating using band 42) and based on time shared spectrum allocation strategy (e.g., band 60 or band 61). The information sent to other nodes may contain additional aspects, parameters and capability information (described above). Examples of additional information include: actual part of spectrum used compared to the predefined or assigned spectrum as the former may be larger than the latter, information related to network components shared between radio communications associated with different operators, type of cell identifier which is unique between operators, and so on. The additional information may further indicate the number of UEs or statistics of UEs (e.g., average) that support time sharing of radio spectrum in a cell, coverage area, during certain time of the day, and their supported frequency band. The information may yet further indicate the comparison of measurement results or statistics based on time shared spectrum and frequency shared spectrum. Examples of measurement results are throughput, bit rate, signal quality etc.

The network node may send the information to other network nodes in real time or within a certain delay. The network node may also collect statistics over certain period of time and report the statistics to the other network nodes. Examples of other network nodes include neighboring base stations (e.g., eNB sending to other eNB over an X2 interface), positioning nodes (E-SMLC in LTE), third nodes, MDT nodes, SON nodes, O&M nodes, OSS nodes, network monitoring nodes, and network planning nodes.

The network node possessing some or all of the above sets of information may forward the information to the other network node either proactively or in response to an explicit request received from the target node.

The other network node receiving the above set of information may e.g. use it for one or more network management tasks. The network management tasks can be long term actions (e.g., valid for several hours or even days) performed by the node in the background (i.e., non real time actions) with the aim of improving network performance, optimizing system capacity, and/or reducing the network deployment and operational costs. Particular network management task examples include network and/or cell planning, configuration of network parameters, network dimensioning (e.g., deployment of number of nodes in a region, determining appropriate power class of radio nodes), dimensioning of the number of radio units and/or transceivers in a radio node, BW allocation in different radio nodes, deciding number of carriers to be used in carrier aggregation, selection of TDD configuration in different parts of the network, upgrading of network to accommodate typical number of users in different set of scenarios and/or radio environment, interference mitigation, management and control, among others.

### Applicability to Multi-Carrier System

Example embodiments disclosed above are also applicable for each serving cell (aka serving carrier or each component carrier (CC)) used in any type of multi-carrier communication system (aka CA system, multi-cell etc) used for radio communication between network node(s) and wireless device. An example of a multi-carrier systems is a CoMP with carrier aggregation. The method may be applied for each cell or carrier independently or jointly depending upon the multi-cell scenario. For example in carrier aggregation, each CC may belong to a different band in which case the time sharing parameters for each CC may be specific to each carrier or may be partly common or identical. According to another aspect, only operation on a subset of CCs (e.g., SCC) may be based on time sharing of radio spectrum whereas on PCC legacy approach is used.

### Nodes Supporting Inter-Operator Time Sharing of Shared Spectrum

The methods described above may be implemented at least in network nodes and wireless devices.

FIG. 11 provides an example embodiment of a network node 1100. The network node 1100 may include a controller 1110, a network communicator 1120, and a time share manager 1130. If the network node 1100 is a radio node, the network node may also include a wireless transceiver 1140, a base band processor 1150, a radio resource manager 1160, and a resource assignment manager 1170.

The wireless transceiver 1140 may be configured to perform radio communications with wireless devices via one or more antennas. The network communicator 1120 may be configured to perform wired and/or wireless communication with other network nodes. It may be configured also to communicate with wireless devices through higher layer signaling via other radio nodes and/or via the wireless transceiver 1140. The base band processor 1150 may be configured to perform base band processing on radio signals received through the wireless transceiver 1140 or on signals prior to being transmitted by the wireless transceiver 1140. The radio resource manager 1160 may be configured to perform radio resource management tasks. The resource assignment manager 1170 may be configured to perform resource assignment tasks. The time share manager 1130 may be configured to perform methods associated with inter-operator time sharing of shared frequency Fs as related to the network as described hereinabove. The time share manager 1130 may communicate with other network nodes via the network communicator, and may communicate with wireless devices via either the wireless transceiver 1140 or the network communicator 1120. The controller 1110 may be configured to control the overall operation of the network node 1100. Any of the components may be shared by two or more operators.

FIG. 11 provides a logical view of the network node 1110 and the components included therein. It is not strictly necessary that each component be implemented as physically separate modules. Some or all components may be combined in a physical module.

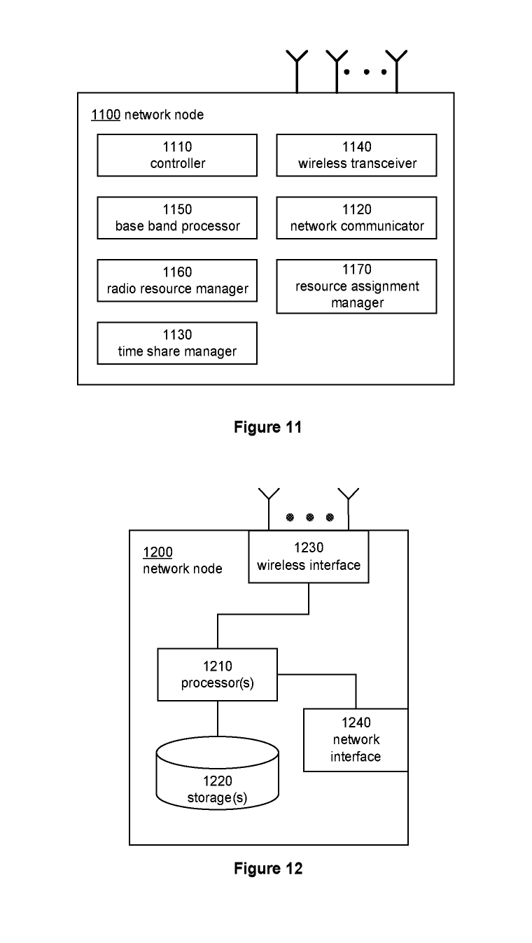

Also, the components of the network node need not be implemented strictly in hardware. It is envisioned that the components can be implemented through any combination of hardware and software. For example, as illustrated in FIG. 12, a network node 1200 may include one or more hardware processors 1210, one or more storages 1220 (internal, external, both) such as memories, and one or both of a wireless interface 1230 (in case of a radio node) and a network interface 1240.

The processor(s) 1210 may be configured to execute program instructions to perform the functions of one or more of the network node components. The instructions may be stored in a non-transitory storage medium or in firmware (e.g., ROM, RAM, Flash) (denoted as storage(s) 1220). Note that the program instructions may also be received through wired and/or or wireless transitory medium via one or both of the wireless and network interfaces. The wireless interface 1230 (e.g., a transceiver) may be configured to receive signals from and send signals to other radio nodes via one or more antennas. The network interface may be included and configured to communicate with other radio and/or network nodes.

To this end, in an example implementation there is provided a radio network node 1200. The radio network node 1200 comprises a wireless interface 1230, one or more processors 1210 and one or more memories 1220. The one or more memories store(s) computer program code, which, when run in the one or more processors 1210, causes the radio network node to acquire information relating to an allocation, or assignment, of a same frequency spectrum Fs to each operator of a plurality of operators during different time periods. The same frequency spectrum Fs is shared among the plurality of operators. Moreover, the wireless interface 1230 is configured to perform radio communication based on, or in accordance with, the acquired information.

The network node 1200 may be shared by two or more operators. For example, portions of the program instructions that cause the hardware components of the network node (processors, wireless interface, network interface) to perform the functions of any of the base band processor, the radio resource manager, the resource assignment manager, and the time share manager may be shared by two or more operators, i.e., executed on behalf of the sharing operators.

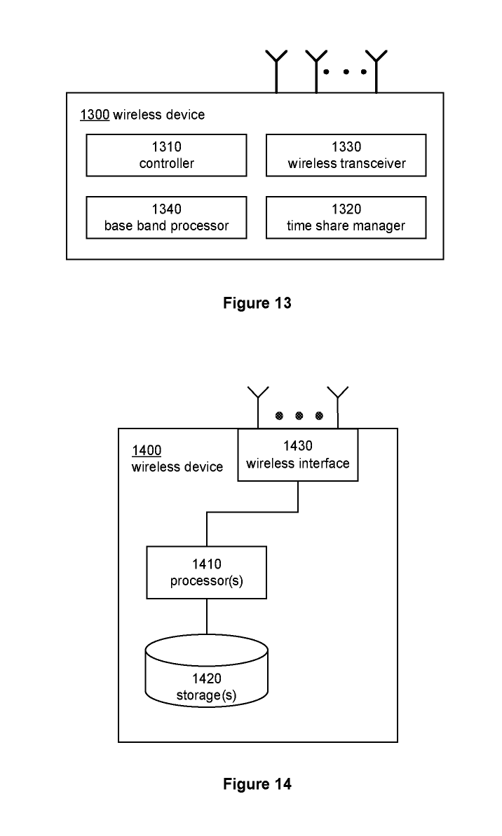

FIG. 13 shows an example embodiment of a wireless device 1300, e.g. in the form of a UE. The wireless device may include a controller 1310, a time share manager 1320, a wireless transceiver 1330 and a base band processor 1340.

The wireless transceiver 1330 may be configured to perform radio communications with radio nodes and/or other wireless devices via one or more antennas. The base band processor 1340 may be configured to perform base band processing on radio signals received through the wireless transceiver or on signals prior to being transmitted by the wireless transceiver 1330. The time share manager 1320 may be configured to perform methods associated with inter-operator time sharing of shared frequency Fs as related to the wireless device 1330 as described hereinabove. The time share manager 1320 may communicate with network nodes via the wireless transceiver 1330. The controller 1310 may be configured to control the overall operation of the network node. Any of the components may be shared by two or more operators.

FIG. 13 provides a logical view of the wireless device and the components included therein. It is not strictly necessary that each component be implemented as physically separate modules. Some or all components may be combined in a physical module.

Also, the components of the wireless device 1330 need not be implemented strictly in hardware. It is envisioned that the components can be implemented through any combination of hardware and software. For example, as illustrated in FIG. 14, the wireless device 1400 may include one or more processors 1410, one or more storages 1420 (internal, external, or both), and a wireless interface 1430.

The one or more processors 1410 may be configured to execute program instructions to perform the functions of one or more of the wireless device. The instructions may be stored in a non-transitory storage medium or in firmware (e.g., ROM, RAM, Flash) (denoted as storage 1420). Note that the program instructions may also be received through a transitory medium via the wireless interface. The wireless interface (e.g., a transceiver) may be configured to receive signals from and send signals to radio nodes and other wireless devices via one or more antennas.

To this end, and in accordance with an example implementation, there is provided a UE 1400. The UE 1400 comprises a wireless interface 1430, one or more processors 1410 and one or more memories 1420. The one or more memories store(s) computer program code, which, when run in the one or more processors 1410, causes the UE to acquire information relating to an allocation, or assignment, of a same frequency spectrum Fs to each operator of a plurality of operators during different time periods. The same frequency spectrum Fs is shared among the plurality of operators. Moreover, the wireless interface 1230 is configured to perform radio communication based on, or in accordance with, the acquired information

The wireless device may be shared by two or more operators. For example, portions of the program instructions that cause the hardware components of the wireless device (processors, wireless interface) to perform the functions of the base band processor and/or the time share manager may be shared by two or more operators, i.e., executed on behalf of the sharing operators.

### Example Advantages

A non-exhaustive list of advantages of one or more aspects of the disclosed subject matter include:
Enable unsynchronized TDD operation without any guard band between adjacent TDD carriers. Therefore operators do not have to coordinate to synchronize their carriers. The synchronized TDD operation means that the carriers have the same frame start timing and also the same TDD configuration is used on all carriers.
Allow independent TDD configuration (i.e., UL-DL subframe configuration and/or special subframe configuration) to be used on all frequency carriers within the frequency band. This in turn enables full flexibility to an operator in terms of selecting a TDD configuration i.e., their percentage of UL and DL subframes can be different and can be chosen according to their own traffic type and demand.
Avoid waste of spectrum since no guard band is needed between adjacent carriers belonging to the same or different operator. This not only saves spectrum but also enhances overall system capacity for all operators using the same band.
Allow the RF component of radio node can be implemented with one RF filter across the entire frequency band. This has following benefits:
   customized products and operator specific RF filters or other RF components are avoid leading to lower product development effort;
   overall cost of radio equipment is reduced since same product can be reused for all operators
Increase peak user data rate since entire band or larger part of a band or at least several carrier frequencies can be used by an operator to serve its users during its allocated time period;
Reduce performance degradation due to guard between adjacent FDD and TDD frequency bands is reduced since each operator can still use very larger part or most of the band for serving users:
   Even if guard band between FDD and TDD bands remains, the use of full or large band enables using larger BW (e.g., 20 MHz) or even using multi-carrier. In case of prior art, the carriers adjacent to guard band region will be smaller and may not support larger bandwidths.
Enable better utilization of spectrum. An operator requiring more resources at certain time of the day can be allocated the spectrum for longer time period.
Enable power saving. This is because the wireless device, radio node, network node using time shared spectrum can go into a sleep mode when the spectrum is used by another operator.
Enable sharing of the radio network equipment between operators. The sharing of network equipment in turn will reduce;
   deployment and operating costs;
   overall energy consumption and cut CO2 emission.
Accommodate new operators interested in launching wireless services in the existing frequency band can easily be accommodated by reassignment of time slots to the existing and new operators.
Reduce interference arising from adjacent carriers. This in turn reduces overall interference received at the radio node and wireless device. This is in particularly beneficial for interference sensitive deployment scenario like heterogeneous network e.g., comprising of high power nodes (HPN) and lower power nodes (LPN).

### Abbreviations

### 3GPP 3^{rd} Generation Partnership Project

### ABS Almost Blank Subframe

### ARFCN Absolute Radio Frequency Channel Number

### BSC Base Station Controller

### CA Carrier Aggregation

CC Component carrier

### CGI Cell Global Identifier

### CDMA Code Division Multiple Access

### CRS Cell-specific Reference Signal

### DB-DC-HSDPA Dual Band-Dual Carrier HSDPA

### DCCH Dedicated Control Channel

### DL Downlink

### DOA Direction Of Arrival

### DwPTS Downlink Pilot Time Slot

### EARFCN E-UTRA Absolute Radio Frequency Channel Number

### EDGE Enhanced Data Rates for GSM Evolution

eNB evolved NodeB

### E-SMLC Evolved SMLC

### E-UTRAN Evolved UTRAN

### FDD Frequency Division Duplex

### GERAN GSM EDGE Radio Access Network

### GNSS Global Navigation Satellite System

### GSM Global System for Mobile Communications

### GPRS General Packet Radio Service

### HD-FDD Half Duplex FDD

HPN High Power Node (such as a macro base station)

### HSDPA High Speed Downlink Packet Access

### HSPA High Speed Packet Access

eICIC Enhanced ICIC

### ICIC Inter-cell Interference Coordination

### IE Information Element

### IRAT Inter Radio Access Technology

LPN Low Power Node (such as a pico base station)

### LTE Long Term Evolution

### MAC Medium Access Control

MBSFN Multicast broadcast single frequency network
MDT Minimization of drive tests
MSR Multi-standard radio

### MIB Master Information Block

### MIMO Multiple-Input Multiple-Out-put

MTBF Mean time before failure

### OSS Operational Support Systems

### OFDM Orthogonal Frequency Division Modulation

### OFDMA Orthogonal Frequency Division Multiple Access

### O&M Operational and Maintenance

### OSS Operational Support Systems

### PA Power Amplifier

### PCI Physical Cell Identifier

PCC Primary component carrier

### PCell Primary Cell

### PDSCH Physical Downlink Shared Channel

### PSC Primary Serving Cell

### RAT Radio Access Technology

### RSRP Reference Signal Received Power

### RSRQ Reference Signal Received Quality

RN Relay node

### RNC Radio Network Controller

### RRC Radio Resource Control

### RRM Radio Resource Management

### RF Radio Frequency

### RX Receiver

### RRU Radio Unit and Remote Radio Unit

SCC Secondary component carrier

### SCell Secondary Cell

### SFN Single Frequency Network

### SIB System Information Block

### SIM Subscriber Identity Module

### SINR Signal to Interference and Noise Ratio

### SM LC Serving Mobile Location Center

### SON Self Organizing Network

### SSC Secondary Serving Cell

### TDD Time Division Duplex

### TD-SCDMA Time Division-Synchronous Code Division Multiple Access

### TDD-LTE TDD Long Term Evolution

### TS Time Slot

### TX Transmitter

### UL Uplink

### UpPTS Uplink Pilot Time Slot

### UARFCN UTRA Absolute Radio Frequency Channel Number

### UMTS Universal Mobile Telecommunications System

### USIM Universal Subscriber Identity Module

### UTRA UMTS Terrestrial Radio Access

### UTRAN UMTS Terrestrial Radio Access Network

### WCDMA Wideband Code Division Multiple Access

X2—an interface for BS-to-BS communication in LTE

### REFERENCES

The following references may be relevant to one or more aspects of the subject matter disclosed in this document and are herein incorporated by reference in their entirety:
[1] 3GPP, TS 36.211, “Evolved Universal Terrestrial Radio Access (E-UTRA); Physical Channels and Modulation”
[2] 3GPP TS 25.101, “User Equipment (UE) radio transmission and reception (FDD)”
[3] 3GPP TS 25.104, “Base station (BS) radio transmission and reception (FDD)”
[4] 3GPP TS 25.102, “User Equipment (UE) radio transmission and reception (TDD)”
[5] 3GPP TS 25.105, “Base station (BS) radio transmission and reception (TDD)”
[6] 3GPP TS 36.101, “Evolved Universal Terrestrial Radio Access (E-UTRA) and Evolved Universal Terrestrial Radio Access (E-UTRAN); User Equipment (UE) radio transmission and reception”
[7] 3GPP TS 36.104, “Evolved Universal Terrestrial Radio Access (E-UTRA) and Evolved Universal Terrestrial Radio Access (E-UTRAN); Base station (BS) radio transmission and reception”
[8] 3GPP TS 05.05, “Radio Transmission and Reception”

1-30. (canceled)

31. A method of allocating a radio spectrum to a plurality of operators, the method comprising:
allocating a same frequency spectrum to each operator of the plurality of operators during different time periods such that the same frequency spectrum is shared among the plurality of operators.

32. The method of claim 31, wherein the allocating a same frequency spectrum to each operator of the plurality of operators during different time periods comprises:
allocating the same frequency spectrum to a first operator during a first time period;
allocating the same frequency spectrum to a second operator during a second time period, which is subsequent to the first time period; and
allocating the same frequency spectrum to a third operator during a third time period, which is subsequent to the second time period.

33. The method of claim 32, the allocating a same frequency spectrum to each operator of the plurality of operators during different time periods further comprises:
allocating the same frequency spectrum to the first operator during a fourth time period, which is subsequent to the third time period;
allocating the same frequency spectrum to the second operator during a fifth time period, which is subsequent to the fourth time period; and
allocating the same frequency spectrum to the third operator during a sixth time period, which is subsequent to the fifth time period.

34. The method of claim 31, wherein the different time periods are non-overlapping in time.

35. The method claim 31, wherein any two adjacent time periods are separated by a guard time.

36. The method of claim 31, further comprising transmitting capability information to another radio network node or to a user equipment, wherein the capability information indicates that the radio network node is capable of performing radio communication sharing the same frequency spectrum during at least one of the different time periods allocated to different operators.

37. The method of claim 31, further comprising receiving capability information from another network node, wherein the capability information indicates that the another radio network node is capable of performing radio communication sharing the same frequency spectrum during at least one of the different time periods allocated to different operators.

38. The method of claim 31, further comprising receiving capability information from a user equipment, wherein the capability information indicates that the user equipment is capable of performing radio communication sharing the same frequency spectrum during at least one of the different time periods allocated to different operators.

39. The method of claim 38, further comprising relaying the received capability information from the user equipment to another radio network node.

40. A method performed by a radio network node, comprising:
acquiring information relating to an allocation of a same frequency spectrum to each operator of a plurality of operators during different time periods, wherein the same frequency spectrum is shared among the plurality of operators; and
performing radio communication based on the acquired information.

41. The method of claim 40, wherein the acquiring of information comprises acquiring the information from another node.

42. The method of claim 41, wherein the acquired information includes one or more parameters that identify the same frequency spectrum and one or more parameters that identify a plurality of different time periods corresponding to the plurality of operators that are sharing the same frequency spectrum during the different time periods.

43. The method of claim 42, further comprising performing, based on the acquired information, a first radio communication in a first time period of the plurality of time periods.

44. The method of claim 40, wherein the acquiring of information comprises acquiring the information from information stored in the radio network node.

45. A method performed by a user equipment (UE), the method comprising:
acquiring information relating to an allocation of a same frequency spectrum to each operator of a plurality of operators during different time periods, wherein the same frequency spectrum is shared among the plurality of operators; and
performing radio communication based on the acquired information.

46. The method of claim 45, wherein the acquiring of information comprises acquiring the information from a memory of the UE.

47. The method of claim 45, wherein the acquiring of information comprises receiving the information from a network node and/or from another UE.

48. The method of claim 45, wherein the acquired information includes one or more parameters that identify the same frequency spectrum and one or more parameters that identify a plurality of different time periods corresponding to the plurality of operators that are sharing the same frequency spectrum during the different time periods.

49. The method of claim 48, further comprising performing, based on the acquired information, a first radio communication in a first time period of the plurality of time periods.

50. The method of claim 45, further comprising transmitting capability information to a radio network node or to another user equipment, wherein the capability information indicates that the user equipment is capable of performing radio communication sharing the same frequency spectrum during at least one of the different time periods allocated to different operators.

51. The method of claim 45, further comprising receiving capability information from another user equipment, wherein the capability information indicates that the another user equipment is capable of performing radio communication sharing the same frequency spectrum during at least one of the different time periods allocated to different operators.

52. The method of claim 45, further comprising receiving capability information from a radio network node, wherein the capability information indicates that the radio network node is capable of performing radio communication sharing the same frequency spectrum during at least one of the different time periods allocated to different operators.

53. A radio network node, comprising:
a wireless interface;
a processor; and
a memory storing computer program code, wherein the computer program code is configured to, when run by the processor, cause the radio network node to acquire information relating to an allocation of a same frequency spectrum to each operator of a plurality of operators during different time periods, wherein the same frequency spectrum is shared among the plurality of operators;
wherein the wireless interface is configured to perform radio communication based on the acquired information.

54. The radio network node of claim 53, wherein the wireless interface is configured to receive the information from another radio network node.

55. The radio network node of claim 53, wherein the radio network node is configured to acquire the information from information stored in the radio network node.

56. The radio network node of claim 53, wherein the acquired information includes one or more parameters that identify the same frequency spectrum and one or more parameters that identify a plurality of different time periods corresponding to the plurality of operators that are sharing the same frequency spectrum during the different time periods.

57. A user equipment (UE) comprising:
a wireless interface;
a processor; and
a memory storing computer program code, wherein the computer program code is configured to, when run by the processor, cause the UE to acquire information relating to an allocation of a same frequency spectrum to each operator of a plurality of operators during different time periods, wherein the same frequency spectrum is shared among the plurality of operators;
wherein the wireless interface is configured to perform radio communication based on the acquired information.

58. The UE of claim 57, wherein the wireless interface is configured to receive the information from a network node and/or another UE.

59. The UE of claim 57, wherein the UE is configured to acquire the information from information stored in the UE.

60. The UE of claim 57, wherein the acquired information includes one or more parameters that identify the same frequency spectrum and one or more parameters that identify a plurality of different time periods corresponding to the plurality of operators that are sharing the same frequency spectrum during the different time periods.
